(19) United States
(12) Patent Application Publication
(10) Pub. No.: US 2010/0028841 A1
(43) Pub. Date: Feb. 4, 2010

(54) Mind-Body Learning System and Methods of Use

(76) Inventors: Ellen Eatough, Mill Valley, CA (US); Paul William Rhoads, San Rafael, CA (US)

Correspondence Address: BELL & ASSOCIATES, 58 West Portal Avenue No. 121, SAN FRANCISCO, CA, 94127, US

(21) Appl. No.: 11/919,366

(22) PCT Filed: Apr. 25, 2006
(86) PCT No.: PCT/US2006/015851

§ 371 Date: Sep. 28, 2009

Related U.S. Application Data
(60) Provisional application No. 60/674,891, filed on Apr. 25, 2005.

(51) Int. Cl. G09B 19/00; G09B 5/06; G09B 7/00

(52) U.S. Cl. 434/308; 434/362

(57) ABSTRACT

The invention describes a method of training, the training resulting in an individual experiencing enhanced intimacy and having an improved sensual and sexual experience. The invention also can comprise a kit comprising a number of training materials and devices, including booklets, audio tapes, video tapes, CDs, DVDs, CD-ROMs, Computers, and Computers connected to Servers via various internet connections or wireless connections that can be used by an individual to be trained to experience enhanced intimacy and have an improved sensual and sexual experience.

### TECHNICAL FIELD OF THE INVENTION

The present invention relates generally to the field of training a human subject to achieve enhanced emotional response and/or an enhanced ability for an activity. More particularly, the field is experiential training and the experiential training results in experiential memory that achieves enhanced intimacy, sensuality, and sexuality for the human subject. More specifically the invention relates to a method of training and biofeedback that can result in a human subject having an improved and more satisfying sex life. In addition, the invention relates to a kit having systems and components that can be used to train a human subject.

### BACKGROUND ART

### Conditioning

Conditioning using a series of multi-sensory inputs and stimuli has been studied in mammals for over one hundred years. In a series of experiments that were to test the salivating response of a dog when presented with food, Ivan Pavlov serendipitously observed that the dog began to salivate when the experimenter appeared with the dog food. He hypothesized that the dog salivated in response to the visual stimulus of the experimenter and that the response might also be stimulated by other unrelated sensory input. He tested his hypothesis using a bell that was rung near the animal when food was offered, and thereby discovered a learning response that is now termed a conditioned response. (See Pavlov (1903) “The Experimental Psychology and Psychopathology of Animals” International Medical Congress, Madrid.)

Training and learning techniques that result in a conditioned response are now widely used in both the corporate and the government world. In addition, considerable basic and applied research has been published during the past century, and, with the advent of molecular biology tools, new data has revealed many sites in the brain that are involved in learning and the conditioned response. Whilst much of the published research has focused on the fear response, it is likely that responses that result in other behaviors are localized within similar regions of the brain. For example, it has been reported that the lateral nucleus of the amygdala (LA) is a crucial site of neural changes that occur during fear conditioning. Of interest, these changes at the molecular level are found to involve mechanisms similar to those already known that underlie long-term potentiation (LTP) in the LA. Behavioral studies coupled with experimental inhibition of protein synthesis have demonstrated that there are striking similarities in the effects on memory storage of post-training pharmacological manipulations and post-training manipulation of sleep. It was suggested that the neurochemical changes that occur across sleep/wake states might provide a mechanism by which sleep modulates specific cellular signaling pathways involved in hippocampus-dependent memory storage. (See Rodrigues et al. (2004) Neuron 44: 75-91; Graves et al. (2001) Trends Neurosci. 24: 237-243.)

In addition, some research has shown that such responses involve dopaminergic neurons in the ventral tegmental area that regulate dopamine (DA) release; DA antagonists can result in a slower learning curve in experimental rats. Others have shown, using standard electrophysiological procedures, that the ventral hippocampal formation (VHPC) can directly influence sensory cortical inputs to the basolateral nucleus of the amygdala (BLA) and may play an important role in the assignment of emotional relevance and memories to specific stimuli based on context. (See, for example, Anzivino and Jentsch (2005) Abstract #2, and Lipski and Grace (2005) Abstract #37, 38^{th} Annual Winter Conference on the Brain, Jan. 25-28, 2005, Breckenridge Colo.)

### Adaptive Unconscious

It has very recently been reported that “(a)ccording to cognitive neuroscientists, we are conscious of only about 5 percent of our cognitive activity, so most of our decisions, actions, emotions, and behavior depends on the 95 percent of brain activity that goes beyond our conscious awareness.” . . . “From the beating of our hearts to driving without having to calculate every turn and stop, we rely on something called the adaptive unconscious, which is all the ways that our brains understand the world that the mind and body must negotiate. The adaptive unconsciousness also makes it possible for us to understand statements such as “children make nourishing snacks” and “prostitutes appeal to pope” without thinking about cannibals munching on children or that the pope has an illicit life.” (See U.S. News and World Report, Health and Medicine, Mysteries of the Mind, Feb. 28, 2005.)

The adaptive unconscious that controls 95% of a person's cognitive activity is heavily influenced by experience. Conditioned associations between thoughts, emotions, images, sounds, words, smells, tastes, touch are made through experience. Experiential memory resides in the adaptive unconscious and influences both unconscious and conscious behavior.

What goes on in the adaptive unconscious is largely responsible for how people make love. To improve lovemaking, lovemaking skills must become part of the adaptive unconscious. To reside in the adaptive unconscious, lovemaking skills must become part of a person's experiential memory.

### Brain Waves

During the 1900s, using electroencephalogram (EEG) data, Hans Berger suggested that the human brain could produce signals in the form of electric currents with particular frequency characteristics. The brain was noted as producing four main frequencies: β-brain waves with a range of about between 13-30 Hz. This has been suggested to be the brain wave of daily life and the conscious mind. It characterizes logical thought, analysis and problem solving. α-brain waves with a range of about between 8-13 Hz. This brain wave dominates in yoga and meditation. It also appears to be present during states of relaxed alertness that appear to favor fast acquisition of facts and a heightened memory. θ-brain waves with a range of about between 4-8 Hz. This brain wave is present during daydreaming and deep meditation. This is also present during sleep dominated by dreams. δ-brain waves with a range of about between 0.54 Hz. This brain wave is present during deep dreamless sleep.

Others have indicated that brain waves with frequencies below 0.5 Hz and above 40 Hz should be considered of utility in correlating brain wave type with brain activity and/or emotional state, however this remains controversial.

As noted above, there are four categories of brain wave patterns. The most rapid brain wave pattern is that of beta, from about 13 Hz to more than 30 Hz. This is the pattern of normal waking consciousness, and is associated with concentration, arousal, alertness, and cognition, while at higher levels, beta is associated with anxiety. As we become more relaxed, the brain wave activity phases into the alpha range, from 8 to 13 Hz. These are die brain wave patterns of deep relaxation, and of what has been called the “twilight state” between sleep and waking, while the higher end of alpha represents a more relaxed yet focused state.

The next phase pattern of brain waves are theta waves, between 4 and 8 Hz. This is considered to be the state of dreaming sleep and also of increased creativity, super-learning, integrative experiences, and increased memory. The next brain wave pattern is delta, that of dreamless sleep, below 4 Hz. Generally people are asleep in delta, but there is evidence that it is possible to remain alert in this state—a very deep trance-like, non-physical state.

As the brain wave patterns change from beta to alpha to theta to delta, there appears to be a corresponding increase in balance between the two hemispheres of the brain. This more balanced brain state is called brain synchrony, or brain synchronization. This balancing phenomenon was noted in early EEG studies of mediators in the 1970s. In deep meditative states, their brain waves shifted from the usual asymmetrical patterns, with one hemisphere dominant over the other, to a balanced state of whole-brain integration, with the same brain wave frequency throughout. As noted below, there are various mental abilities and experiences that naturally happen in these different brain wave patterns, many of which are rather remarkable.

### Relaxation Response

Meditation is a conscious mental process that induces a set of integrated physiological changes termed the relaxation response. Brain regions active during meditation are the dorsolateral prefrontal and parietal cortices, the hippocampus and parahippocampus, the temporal lobe, the pregenual anterior cingulate cortex, the striatuin, and the pre- and post-central gyri (Lazar et al. (2000) Neuroreport. 11: 1581-1585).

Different meditation interventions can also result in differential heart rate and a decrease in coherence between heart rate and respiratory dynamics (breathing) (Peng et al. (2004) Int. J. Cardiol. 95: 19-27). The most likely candidate molecules or signaling agents for such responses are now believed to be endocannabinoids. These molecules interact with endogenous receptors and induce an intracellular (and possibly extracellular) signal that is nitric oxide. The effects of nitric oxide are well known in the art and regulate neural, immune, and vascular functions. (Stefano et al. (2003) Med. Sci. Monit. 9: RA63-75; Gonzalez-Cadavid and Rajfer (2004) Exp. Gerontol. 39: 1705-1712.)

### Studies in Brainwave Entrainment Involving Binaural Beats

In a remarkable report published in Scientific American, a form of brainwave entrainment response to what were termed Binaural Beats were identified in the early 1970s. This single publication has resulted in a surge in interest in the use of sound to influence brain wave patterns and, perhaps, emotion and responses to discrete stimuli. (See Oster (1973) Scientific American 229: 94-102.)

Binaural Beats occurred when two separate tones were tuned slightly differently from one another (for example 18% of one another—a range called the “Critical Bandwidth”). The speed of the beats is governed by the difference in the frequency of the two notes: a left channel tone of 100 Hz and a right channel tone of 105 Hz would cause a 5 Hz pulse to arise as an interference pattern. The brain is believed to entrain and slow its function to this 5 Hz speed and therefore an altered state of consciousness would result. It was also noted that listening to these two frequencies through headphones caused not only the brainwave entrainment phenomenon in the individual, but a synchronicity of the electrical activity of the right/left hemispheres as well.

A new era in the ability to learn, be creative, remember, control our moods, reduce stress, resolve unwanted behavior patterns, and a host of other desirable ends, was heralded with the publishing of the report by Oster (Oster, (1973) supra).

Oster's report described how the pulsations called binaural beats occurred in the brain when tones of different frequencies were presented separately to each ear. As a result, it appears that the entire brain becomes entrained to the internal beat and begins to resonate to that frequency. Oster had apparently discovered a method for what is called “entrainment” of brain wave patterns.

Simultaneously, Robert Monroe of the Monroe Institute (Faber, Va.) was also investigating binaural beats. In many experiments using an EEG machine to monitor a subject's electrical brain wave patterns, Monroe observed that he could indeed entrain brain wave patterns using binaural beats. In addition, he noted that the response did not only happen in the area of the brain responsible for hearing, or only in one hemisphere or the other, but rather the entire brain appeared to resonate, the wave forms of both hemispheres becoming identical in frequency, amplitude, phase, and coherence. (See, for example, U.S. Pat. No. 5,213,562)

Research reported by Fehmi also apparently confirmed the observation that hemispheric synchronization and brain entrainment can be induced by binaural beats (In: Hutchison (1986) Megabrain, Ballantine Books New York, p. 219).

Atwater has described the neurophysics of the binaural beat brain entrainment process: “(w)ithin the sound processing centers of the brain, pulse stimulation provides relevant information to the higher centers of the brain. In the case of a waveform phase difference the electron pulse rate in one part of a sound-processing center is greater than in another. The differences in electron pulse stimulation within the sound processing centers of the brain are an anomaly. This anomaly (the difference in electron pulse stimulation) comes and goes as the two different frequency wave forms mesh in and out of phase. As a result of these constantly increasing and decreasing differences in electron pulse stimulation, an amplitude-modulated standing wave (the binaural beat) is generated within the sound processing centers of the brain itself. It is this standing wave that may act to entrain brain waves. (See Atwater (1988) The Monroe Institute's Hemi-Sync Process; A theoretical perspective. The Monroe Institute of Applied Sciences, p 4.)

Atwater further states, “(a) conventional binaural beat generates two amplitude modulated standing waves, one in each hemisphere's olivary nucleus. Such binaural beats will entrain both hemispheres to the same frequency, establishing equivalent electromagnetic environments and maximizing interhemispheric neural communication” (Atwater, supra, p 7).

Acoustic Brainwave Entrainment uses sound technology to entrain brain wave patterns, giving us the ability to influence and/or create tranquility, pain control, creativity, euphoria, excitement, focused attention, relief from stress, enhanced learning ability, enhanced problem solving ability, increased memory, accelerated healing, behavior modification, and improvements in mental and emotional health.

### Additional Studies in Brainwaves, Brainwave Entrainment, and Brain Physiology

Hutchison has reported that “[n]ew breakthroughs in neuroscience and microelectronics have permitted scientists to ‘map’ the electrical and chemical activity of the brain in action. Scientists have used the new technology to monitor the brains of those meditators, artists, and other rare individuals who are able to enter peak domains at will and to map their brain activity during those peak states. Their first findings were that those peak states are not mysterious and unpredictable phenomena, but are very clearly linked to very specific patterns of brain activity. These include dramatic changes in brain wave activity, hemispheric symmetry, and rapid alterations in the levels of various neurochemicals. If we could learn to produce these patterns of brain activity, they reasoned, we should be able to produce the peak states they are associated with. . . . They found that by using types of mechanical stimulation, such as . . . precise combinations of pulsating sound waves . . . they could actually produce those same ‘peak state’ brain patterns in ordinary people . . . ” (In: Hutchison (1994) Megabrain Power, Hyperion, New York N.Y., pp. 22-23).

Using sound in these ways, it appears to be possible to make profound changes in brainwave patterns and states of consciousness, observable on brainwave mapping equipment (such as EEG), as well as positive changes in the body, measurable with blood tests, bio-feedback equipment and other sophisticated procedures. Individuals who experience such changes in Brainwave patterns during Brainwave Entrainment sessions involving specific sensory input can be conditioned to produce the same Brainwave patterns on their own as a response to other stimuli in their external and/or internal environment which they have been conditioned to associate with Brainwave Entrainment sessions.

Acoustic Brainwave Entrainment uses sound technology to entrain brain wave patterns, giving us the ability to influence and/or create tranquility, pain control, creativity, euphoria, excitement, focused attention, relief from stress, enhanced learning ability, enhanced problem solving ability, increased memory, accelerated healing, behavior modification, and improvements in mental and emotional health.

Others have noted that these slower brain wave patterns are accompanied by deep tranquility, flashes of creative insight, euphoria, intensely focused attention, and enhanced learning abilities. For example, Fehmi and Fritz noted that hemispheric synchronization represents “the maximum efficiency of information transport through the whole brain” and “is correlated experientially with a union with experience, and ‘into-it-ness’. Instead of feeling separate and narrow-focused, you tend to feel more into it—that is, unified with the experience, you are the experience—and the scope of the individual's awareness is widened a great deal, so that you're including many more experiences at the same time. There's a whole-brain sensory integration going on, and it's as if you become less self-conscious and you function more intuitively.” (See Fehmi and Fritz (1980) Open Focus: The Attentional Foundation of Health and Well-Being, Somatics, Spring 1980.)

One of the observed effects of this type of sound-induced brain synchronization is increased learning ability. What is now known as “super-learning” began in the late 1960s and early 1970s with the work of Georgi Lozanov. Lozanov used deep relaxation combined with synchronized rhythms in the brain to cause students to produce alpha waves. In this state, he found that students learned over five times as much information in less time per day, with greater retention. (See Lozanov and Gateva (1988) Language Teacher's Suggestopedic Manual, Gordon and Breach, New York, N.Y.; Lozanov (1978) Suggestology and Outlines of Suggestopedia, by Lozanov, Gordon and Breach, New York, N.Y.)

Many other researchers have described the benefits of alpha and theta brain wave states. Budzynski has done extensive research on learning and suggestion when the brain is in a theta state. Theta, Budzynski suggested, is the state in which “super-learning” takes place—when in theta, people are able to learn new languages, accept suggestions for changes in behavior and attitudes, or memorize large amounts of information. He says: “We take advantage of the fact that the hypnagogic [theta] state, the twilight state . . . has these properties of uncritical acceptance of verbal material, or almost any material it can process.” In this state, Budzynski says, “a lot of work gets done very quickly.” (See, for example, Budzynski (1977) Tuning in on the Twilight Zone, Psychology Today, August 1977; Budzynski (1983) A Brain Lateralization Model for REST, First International Conference on REST and Self Regulation, Denver, Colo., Mar. 18, 1983.)

Biofeedback methods of teaching subjects to increase theta EEG activity in experimental volunteers have been known for several decades. Some have showed a clear relationship between volunteers' baseline frontal EMG levels and the effect of the training methods. Sittenfeld et al. reported that not only that amounts of theta can be reliably increased but that training techniques could be adapted to the physiological characteristics of the individual baseline levels of frontal EMG levels (Sittenfeld et al. (1976) Biofeedback Self. Regul. 1: 31-46). Bird et al. reported that following biofeedback training to control high-frequency EEG responses in the 35- to 45-Hz (40 Hz) and 21 to 31 Hz ranges some volunteers demonstrated increase and suppression of 40 Hz EEG without feedback (Bird et al. (1978) Biofeedback Self Regul. 3: 1-11.)

Researchers Elmer and Alyce Green have also studied these phenomena, finding that memories experienced in a theta state “were not like going through a memory in one's mind but rather like an experience, a reliving.” Those producing theta waves also had “new and valid ideas or synthesis of ideas, not primarily by deduction but springing by intuition from unconscious sources.” In their book “Beyond Biofeedback”, the Greens further discussed many remarkable effects of the theta brain wave state. They found that those producing theta waves became highly creative. They had life-altering insights, what the Greens called “integrative experiences leading to feelings of psychological well-being”. On psychological tests, subjects were reported as being “psychologically healthier, had more social poise, were less rigid and conforming, and were more self-accepting and creative”. Another effect was that these subjects apparently became very healthy. Emotionally, these people had “improved relationships with other people as well as greater tolerance, understanding, and love of oneself and of one's world.” (Green and Green (1977) Beyond Biofeedback. New York, Delacourt, New York, N.Y.)

Other studies have suggested that states of brain synchronization increase memory. Research reported by McGaugh on memory and theta waves showed that “the more theta waves appeared in an animal's EEG after a training session, the more it remembered. This was true in all cases . . . . Apparently, the best predictor of memory was the amount of theta waves recorded in the animal's brain. [Theta waves] show that the brain is in the right state to process and store information.” (In: Pines (1973) The Brain Changers: Scientists and the New Mind Control, Harcourt Brace Jovanovich, New York, N.Y.)

For several decades it has been understood that for memories to form the brain must undergo a biochemical process termed long-term potentiation (LTP), involving electrical and chemical changes in the neurons associated with memory. Without LTP, incoming information is not stored, but rather quickly and totally forgotten. Lynch and associates discovered that the key to LTP is the theta brain wave pattern. “We have found the magic rhythm that makes LTP. There's a magic rhythm, the theta rhythm,” According to Lynch this is the natural rhythm of the hippocampus, the part of the brain essential for the formation and storage of new memories and the recall of old memories (Lynch and Baudry (1984) Science 224: 1057-1063).

The exact cause of these waves is still unknown; however, the known fluctuations in calcium ion movement, sodium/potassium ion transport, oscillations of other ion (such as glucose, ATP, GABA, acetylcholine, enkephalins, etc.) movements within the brain regions, contrasting firing rates between pyramidal cells, neurons, and granule cells, and the potential created between different regions of the brain, are believed to have a role in the phenomenological observations (see, for example, Yokata and Anton (2004) Neuron 43: 599-601).

Many researchers believe different brain wave patterns are linked to the production in the brain of various neurochemicals associated with relaxation and stress release, increased learning and creativity, memory, and other desirable benefits. These neurochemicals include beta-endorphins, acetylcholine, vasopressin, and serotonin.

The increased production of these different neurochemicals can greatly enhance memory and learning. A research team reportedly found that when a group of normal human subjects were given substances that increased acetylcholine production in the brain, the subjects showed great improvement in long-term memory; in a separate study, students taking acetylcholine enhancers had improved memory and increased ability to learn lists of words (Starr (1983) Brain Drugs, Omni, February 1983).

Other neurochemicals that are produced in the brain in response to binaural beats have been associated with increased memory, learning, and other benefits. Men taking vasopressin apparently showed significant improvement in memory, leaning, and reaction time. In another study, sixteen normal healthy subjects of average intelligence were given vasopressin several times and showed dramatic improvement in their ability to learn and remember. (See Hutchison (1994) supra pp. 147-148.) Others found that vasopressin had a long-term “cementing effect on consolidation of information” (see Bylinski, (1978) Mood Control, Scribner, New York, N.Y.).

Vasopressin is also associated with and enhances production of theta waves that are associated with increased access to memories and increased creativity. Vasopressin also stimulates the release of endorphins and has restored memory in amnesia victims. (Koob and Bloom (1982) Ann. Rev. Physiol. 44: 571-582; Koob et al. (1989) Brain Res. Bull. 23: 359-364; and Legros et al. (1978) Lancet 1(8054) 41-42.)

Numerous studies dissecting the basic mechanisms that control sleep regulation have led to considerable improvement in our knowledge of sleep disorders. It is now well accepted that transitions between sleep and wakefulness are regulated by complex neurobiologic mechanisms, which, ultimately, can be delineated as oscillations between two opponent processes, one promoting sleep and the other promoting wakefulness. The role of several neurotransmitter or neuromodulator systems, including noradrenergic, serotonergic, cholinergic, adenosinergic, and histaminergic systems and, more recently, the hypocretin/orexin and dopamine systems, has been clearly established.

Amphetamine-like stimulants are known to increase wakefulness by blocking dopamine reuptake, by stimulating dopamine release, or by both mechanisms. Modafinil may increase wakefulness through activation of noradrenergic and dopaminergic systems, possibly through interaction with the hypocretin/orexin system. Caffeine inhibits adenosinergic receptors, which in turn can produce activation via interaction with GABAergic and dopaminergic neurotransmission. Nicotine enhances acetylcholine neurotransmission in the basal forebrain and dopamine release. Understanding the exact role of the hypocretin/orexin and dopamine systems in the physiology and pharmacology of sleep-wake regulation may reveal new insights into current and future wakefulness-promoting drugs. (Boutrel and Koob (2004) Sleep 27: 1181-1194.)

Rosenzweig has made many contributions to the understanding of learning and behavior in the context of neuronal plasticity, training, and age. Plasticity of brain and behavior ranges from examples of plasticity restricted to an early critical period to other examples that show lifelong plasticity, but these two polar opposites are far from covering the field. Rather, it appears that there are a number of patterns by which different measures of plasticity vary as a function of age. (Rosenzweig (2003) Dev. Neuropsychol. 24: 523-540).

### Brain Waves, Conditioned Response, and the Adaptive Unconscious

Through brainwave entrainment processes humans can learn to evoke a brainwave pattern. Humans can also be conditioned to associate a brainwave pattern with a specific thought, emotion, behavior, or sensory experience and with combinations of these thoughts, emotions, behaviors and sensory experiences. Sensory experience includes, but is not limited to sight, sound, smell, and touch. Sight includes: Image, combinations of images, animation of images, visual sequences consisting of live action video and/or 2D and/or 3D graphic video. Sound includes: A singular sound, a combination of singular sounds, sequences of sounds, combinations of sound sequences, words, combinations of words, statements, sentences, and music of all kinds.

When such conditioning has occurred within an individual, the brainwave pattern involved in the conditioning of that individual can be used to elicit and support the presence of the conditioned thought, emotion, behavior, and/or sensory experience (or combinations) to which the brainwave pattern has been associated. Likewise the thought, emotion, behavior and/or sensory experience can elicit and support the presence of the brainwave pattern. This conditioned and reciprocal association resides in the adaptive unconscious. When a conditioned response between a brainwave pattern and a behavior, is established the condition and the response can be interchangeable; meaning either can elicit the other.

When a person consistently associates a brainwave pattern with a thought, emotion, behavior, sensory experience (or combination) over time that association becomes part of both the long term memory and the adaptive unconscious of that person. Therefore, the association in the long term memory and adaptive unconscious of that person can be used without conscious effort and can also be used deliberately.

Specific brainwave patterns can enhance a sexual experience. When brainwave patterns that enhance a sexual experience are consistently associated with sex, the presence of sex can elicit those brainwave patterns and those brainwave patterns can then be used to enhance that sexual experience. The enhanced sexual experience then reinforces the brainwave patterns and the brainwave patterns reinforce the enhanced sexual experience. Over time these enhanced experiences can become part of the adaptive unconscious way that a person makes love. This is a prerequisite to sexual spiritual fulfillment.

### Subliminal Sensory Signals

Of related importance is the use of subliminal sounds or signals that have been historically used to achieve increased sales of products advertised on the radio or television, or to prevent shoplifting. Subliminal sounds are those audible sounds that are generally understood in the art as being those that are heard by an individual but that individual is not consciously aware of those sounds. Subliminal sounds or signals can rely on an individual's preconditioning, whether by training or by the cultural environment, and that individual's response to an audible or visual message or signal that is heard or seen but is not consciously noticed, thereby acting upon the subliminally perceived message or signal (see, for example, Merikle (2000) “Subliminal Perception” In Kazdin (Editor), Encyclopedia of Psychology, Oxford University Press, New York N.Y., 7: 497-499).

### Neurolinguistic Programming (NLP)

Based on common associations within the adaptive unconscious of nearly all people, sensory input can be used to elicit thoughts, emotions, attitudes and behaviors. Words, images, and sounds that are commonly associated with personal empowerment, self-expression, a positive self image, can be used to empower life skills.

NLP was devised first to make people aware of their unconscious limiting thought and behavior patterns, and, second, to show them how they can change these automatic patterns and to create new ways of thinking and feeling. These new patterns open up new choices and new behaviors that help people achieve their goals. While NLP can be applied to nearly any type of human activity, from business to social relations, some practitioners use it exclusively to enhance the healing process.

### Mantras for Enhancing Sex and Sexual Relationships

Mantras are energy-based sounds. Saying any word produces an actual physical vibration. Over time, if we know what the effect of that vibration is, then the word may come to have meaning associated with the effect of saying that vibration or word. This is one level of energy basis for words. Another level is intent. If the actual physical vibration is coupled with a mental intention, the vibration then contains an additional mental component that influences the result of saying it. The sound is the carrier wave and the intent is overlaid upon the wave-form, just as a coloured gel influences the appearance and effect of a white light. In either instance, the word is based upon energy. Nowhere is this idea more true than for Sanskrit mantra. For although there is a general meaning which comes to be associated with mantras, the only lasting definition is the result or effect of saying the mantra. (See, for example, Thomas Ashley Farrand, “Healing Mantras” Saraswati Publications LLC, Arcadia Calif.)

Mantras start a powerful vibration that corresponds to both a specific spiritual energy frequency and a state of consciousness in seed form. Over time, the mantra process begins to override all of the other smaller vibrations, which eventually become absorbed by the mantra. After a length of time that varies from individual to individual, the great wave of the mantra stills all other vibrations. Ultimately, the mantra produces a state where the organism vibrates at the rate completely in tune with the energy and spiritual state represented by and contained within the mantra. At this point, a change of state occurs in the organism. The organism becomes subtly different. Just as a laser is light which is coherent in a new way, the person who becomes one with the state produced by the mantra is also coherent in a way which did not exist prior to the conscious undertaking of repetition of the mantra.

### Music Stimulation

Neuroacoustic brainwave entrainment generally uses music or other familiar sounds to measurably induce physiological and biochemical changes in a receptive individual. Forms of neuroacoustic brainwave entrainment involving the use of music has been developed that have been shown to have positive effects upon the ability of an individual to relax and be more receptive to a learning or a training experience. Neuroacoustic brainwave entrainment generally uses music or other familiar sounds to measurably induce physiological and biochemical changes in a receptive individual.

Several related studies have shown that playing music to individuals in a stressful environment, such as surgery, results in a reduced need by the individual for pain and sedation medications and had a lower incidence of post-operative complications (see, for example, Mandle et al. (1990) Radiology 174: 737-739; Leserman et al. (1989) Behav. Med. 15: 111-117).

Others have shown that music that elicits specific emotions can induce physiological changes that may be beneficial to relaxation and behavioral therapies. Such studies reported that plasma levels of norepinephrine (noradrenaline), endorphin, and the stress hormone cortisol, together with galvanic skin responses, in student volunteers, changed significantly when the students were played music in a controlled environment. In addition, subjects that were exposed to music imaging (music played in the presence of images) had lower plasma beta-endorphin levels compared with those exposed to silent imaging or music listening when measured after a period of two hours. (See VanderArk and Ely (1002) Percept. Mot. Skills 74: 1079-1090; McKinney et al. (1997) J. Behav. Med. 20: 85-99).

In another example, music played to surgery patients before general anesthesia produced higher production of alpha waves, indicating deeper states of relaxation, and had marked decreases in plasma levels of the cortisol, ACTH, and endorphin. This decrease appeared to boost the immune system and reduce recovery time (see Satoh et al. (1983) Masui 32: 1206-1211).

Using sound in these ways, it appears to be possible to make profound changes in brainwave patterns and states of consciousness, observable on brainwave mapping equipment (such as EEG), as well as positive changes in the body, measurable with blood tests, galvanic monitors, breathing monitors, bio-feedback equipment and other procedures.

### Heart Rate Variability

Using heart rate variability (HRV) feedback to learn to self-generate physiological coherence has innumerable potential applications in performance enhancement. In short, heart rhythm coherence feedback is a practical and powerful tool to facilitate people in developing a greater awareness of the connection between their emotions, physiology, and behavior, and ultimately to achieve greater mastery of their health and well-being.

In previous studies of the relationship between HRV, respiration rate, blood pressure waves and other somatic systems, it was reported that when one is sincerely experiencing positive emotional states, there is a tendency for systems to naturally entrain and, further, that this entrainment process can be facilitated by specific techniques that shift conscious attention to the area around the heart and/or by specifically designed music. A shift in perception and a greatly increased intuitive awareness has also been subjectively observed in many subjects when this entrainment occurs.

### Sexual Dysfunction and Sex Therapy

There currently appears to be a persistent epidemic of sexual dissatisfaction and psychologically based sexual dysfunction resulting in large part from the fact that most people do not know how to interact intimately and make love in truly satisfying ways. What most people learn about sex from the typical sources (peers, popular media, and pornography) is often incomplete, misleading and/or simply erroneous and merely serves to widen the gap between expectations and personal experience. These typical sources lack the information individuals need to enjoy sustainable sexual satisfaction and to experience sexual-spiritual fulfillment. As adults mature, these problems are often compounded by life's challenges and changes (such as financial stress, marriage, children, hormone changes). In the context of these challenges and changes lovemaking is rarely improved and often diminished. Billions of dollars are spent each year by adults in pursuit of products and services that enhance sex appeal, sexual desire and help overcome sexual dysfunction. Ironically, with all that is being done and spent to attract and enable sex physically, there is very little being done and spent to improve the “experience” of sex, physically, emotionally and energetically. What adults need is a practical, effective and pleasurable way to develop new lovemaking skills to satisfy their evolving physical, emotional and energetic sexual needs as a complement to the other products they may currently consume to improve their love lives.

There is currently no practical and affordable way for adults to effortlessly and effectively learn the kind of lovemaking skills that enable a lifetime of sexual satisfaction and sexual-spiritual fulfillment.

There is therefore a need in the art for methods, systems, and kits that can provide Experiential Lovemaking Training to individuals and that can result in an enhanced experiential memory.

### DISCLOSURE OF THE INVENTION

The present invention relates generally to the field of enhancing and improving an individual's response and activity by improving an individual's experiential memory. The invention can be used to train an individual to improve an activity using both active and passive learning experiences. The invention comprises a method of learning, systems, and kits comprising audio, video, visual text, interactive, and tactile devices that are used to train an individual. The individual can use the kit, system, or the method of training to improve said individual's experiences and responses when performing an activity. In a preferred embodiment the training is experiential training. The method combines the emotional power of motion pictures with the personal impact of interactive entertainment and the transformative effect of neuroacoustic technology.

In one embodiment, the present invention relates to the field of enhancing and improving an individual's emotional, sensual, and sexual experiences. More specifically the invention is drawn to a method of experiential training, the experiential training resulting in an improved sensual and sexual fulfillment, the method comprising the steps of providing at least one image, the image comprising at least one human body or body part, providing at least one video recording, the video recording comprising at least one human indulging in a sexual and/or intimacy-building activity, providing at least one audio recording, the audio recording comprising subliminal and/or non-subliminal sound, wherein the subliminal sound is separated into at least a first subliminal sound and a second subliminal sound and the first subliminal sound is pitched at a frequency of at least 4 Hz from the second subliminal sound; viewing the image for at least between 1/60 of a second and one minutes; viewing the video recording for at least between 1/30 of a second and five minutes; and listening to the audio recording for at least between 1/60 of a second and fifteen minutes; optionally repeating any one of the above recited steps; and the training resulting in an improved intimacy and/or sensual and sexual fulfillment. In an alternative embodiment the subliminal sound comprises a single subliminal sound. In one embodiment, the image is still. In an alternative embodiment, the image is animated. In another embodiment, the invention provides a method for training a human subject, the training resulting in an improved sensual and sexual fulfillment for the human subject, the method comprising the steps of: (i) providing at least one image to the human subject, the image comprising at least one human body part; (ii) providing at least one video recording to the human subject, the video recording comprising at least one human indulging in an activity, the activity selected from the group consisting of sensual activity, sexual activity, verbal communication, and non-verbal communication; (iii) providing at least one audio recording to the human subject, the audio recording comprising a sound; (iv) presenting the image to the human subject for at least 1/60 of a second; (v) presenting the video recording to the human subject for at least 1/30 of a second; (vi) presenting the audio recording to the human subject for at least 1/60 of a second; and (vii) optionally repeating any one of steps (i), (ii), (iii), (iv), (v), and (vi); the training resulting in an improved sensual and sexual fulfillment for the human subject. The steps can be repeated at least once. In a preferred embodiment the steps are repeated selected from the group consisting of, once, twice, thrice, four times, five times, ten times, fifteen times, and twenty times. In a preferred embodiment, the training is experiential training. In another preferred embodiment the sound is selected from the group consisting of subliminal sound and non-subliminal sound. In a more preferred embodiment, the sound is selected from the group consisting of sounds in the range of 1 to 10 Hz, 10 to 100 Hz, 100 to 1000 Hz, 1000 to 10000 Hz, and 10000 to 25000 Hz. In a still more preferred embodiment, the sound is provided at a range of frequencies that evokes a physiological and measurable reaction in an individual and wherein the physiological reaction is measured using a device selected from the group consisting of, an electroencephalogram (EEG) device, a galvanic skin response monitor, a respiration monitor, and the like. In an additional embodiment, the sound is selected from the group consisting of music, voices, synthetic sounds, natural sounds, and any combination thereof. In another preferred embodiment, the method further provides at least one medium that recites experiential lovemaking techniques. In a more preferred embodiment, the medium is in book format. In another preferred embodiment, the method further provides a step of presenting the human subject with a profile questionnaire.

In another embodiment, the method further comprises providing the image on a viewing device, the viewing device selected from the group consisting of a visual display unit (VDU), a light-emitting diode (LED) screen, a liquid crystal display (LCD) screen, a reflecting screen, and a book; the VDU comprising an image selected from the group consisting of at least any one of the images or the video recordings of the aforementioned steps, an image of at least one other individual, an image of a non-human organism an image of a structure, an image of a locality, an abstract image, and any combination thereof. In a yet further preferred embodiment, intimacy-building and/or sexual activity is simulated. In a yet further preferred embodiment, the intimacy-building and/or sexual activity is selected from the group consisting of foreplay, oral sex, masturbatory sex, sexual intercourse, penis to G-spot contact, penis to cervix contact, pubic bone to clitoris contact, penis to anus contact, penis to penis contact, clitoris to clitoris contact, clitoris to limb contact, penis to limb contact, limb to limb, face to back, touch, sensual massage, individual muscular contractions, individual muscular movements, breathing techniques, intimate verbal communication, intimate non-verbal communication, and any combination thereof. In a more preferred embodiment, the video comprises a sound, wherein the sound is selected from the group consisting of sounds in the range of 1 to 10 Hz, 10 to 100 Hz, 100 to 1000 Hz, 1000 to 10000 Hz, and 10000 to 25000 Hz. In a yet more preferred embodiment the sound is selected from the group consisting of subliminal sound and non-subliminal sound. In a still more preferred embodiment, the sound is provided at a range of frequencies that evokes a physiological and measurable reaction in an individual and wherein the physiological reaction is measured using a device selected from the group consisting of, an electroencephalogram (EEG) device, a galvanic skin response monitor, a respiration monitor, and the like. In an additional embodiment, the sound is selected from the group consisting of music, voices, synthetic sounds, natural sounds, and any combination thereof.

In one embodiment, the image is presented in at least a two-dimensional format. In an additional embodiment, the image is presented in a three-dimensional format and the subject or individual wears a three-dimensional viewing device. In a preferred embodiment, the three-dimensional viewing device is a pair of glasses. In a more preferred embodiment, the pair of glasses is selected from the group consisting of glasses with a red/green paired optical filters and glasses with a horizontal/vertical paired optical filters. In a yet more preferred embodiment, the three-dimensional viewing glasses comprise horizontal/vertical paired polarizing filters. In a yet further additional embodiment, the pair of glasses comprises light-emitting diodes (LEDs). In an additional embodiment, the glasses present images in color. In a more preferred embodiment, the color comprises color pulsations. In a still more preferred embodiment, the color pulsations are generated electronically by a software and computer system that comprises an algorithm that is derived from numbers in a Fibonacci formula.

In one embodiment, the audio recording is recorded on a recording format, more preferably the recording format is selected from the group consisting of a compact disc (CD), a CD-ROM, a DVD, a DVD-ROM, an MP3 recorder, an audio tape, a digital audio file recorder, a digital video file recorder, a hard disc drive device, a laser disc, a computer memory disc, a computer chip, and any combination thereof.

In another embodiment the video recording is recorded on a recording format, the recording format selected from the group consisting of a CD-ROM, a digital video disc (DVD), a DVD, a DVD-ROM, a VHS tape, a video tape, a laser disc, an MP3 recorder, a digital audio file recorder, a digital video file recorder, a hard disc drive device, a computer memory disc, a computer chip, and any combination thereof.

In a yet further embodiment, at least one element of the method is transmitted using an electron-conducting material, the electron-conducting material selected from the group consisting of metal wire, polymeric wire, digital cable, and telephone lines.

In another embodiment, at least one element of the method is transmitted using electromagnetic radiation impulses, the electromagnetic radiation impulses selected from the group consisting of wireless waves, radio waves, and microwaves.

In another embodiment, at least one element of the method is transmitted using photon impulses, the photon impulses transmitted using devices selected from the group consisting of fiberoptic cables, fiberoptic fluids, and fiberoptic wires.

In a further embodiment, the method comprises a biofeedback system, the biofeedback system selected from the group consisting of heart rate variability (HRV) feedback system, mantra recitation, and meditation.

In a still further embodiment, the method comprises Feng Shui design principles.

In a still further embodiment, the method comprises Color Treatment, the Color Treatment thereby enhancing emotional and energetic effects of the training method upon the human subject.

In one embodiment the method of training can be performed over a period of several months. In another embodiment the method of training can be performed over a period of several weeks. In yet another embodiment the method of training can be performed over a period of several days. In a still further embodiment the method of training can be performed over a period of several hours. In a yet still further embodiment the method of training can be performed over a period of several minutes. More preferably the method of training is performed for between several minutes and several hours. In another preferred embodiment, the method of training is repeated at least once at a suitable time period following the first instance of training.

In an additional embodiment, the method or the kit comprises using a virtual reality (VR) device, the VR device comprising VR viewing goggles, VR gloves, and, optionally, a VR suit or VR clothing.

In a further embodiment, the method or the kit comprises using a cyber-sex device.

Another embodiment of the invention comprises the above recited method wherein the visual recording further comprises at least one audio recording, the audio recording comprising a subliminal sound, wherein the subliminal sound is separated into at least a first subliminal sound and a second subliminal sound and the first subliminal sound is pitched at a frequency of at least 18 Hz from the second subliminal sound. A more preferred embodiment of the method further comprises wherein the subliminal sound is selected from the group consisting of sounds in the range of 1 to 10 Hz, 10 to 100 Hz, 100 to 1000 Hz, 1000 to 10000 Hz, and 10000 to 25000 Hz. In a more preferred embodiment, the subliminal sound is selected from the group consisting of music, voices, synthetic sounds, and any combination thereof. In another preferred embodiment, the audio recording comprises a narrative.

In an additional embodiment the method further comprises a step of measuring a physiological reaction in an individual and wherein the subliminal and/or non-subliminal sound is provided at a range of frequencies to evoke a physiological reaction in an individual; and wherein the physiological reaction is measured using an electroencephalogram (EEG) device, a galvanic skin response monitor, a respiration monitor, or the like. In a yet more preferred embodiment the physiological reaction is a change in brain wave pattern. In a most preferred embodiment the brain wave pattern is selected from the group consisting of α-brain wave patterns, β-brain wave patterns, δ-brain wave patterns, and θ-brain wave patterns.

In another embodiment, the invention comprises a video recording comprising color effects, the color effects optimized for experiential training and improving experiential memory.

In a yet further embodiment, the invention comprises measuring and comparing the brain wave pattern with a brain wave pattern from an individual having experientially entrained to retain an improved experiential memory.

In another embodiment, the invention comprises a method comprising reading text that teaches experiential lovemaking techniques. In one embodiment, the text is in a book format. In another embodiment, the text is in a digital format.

In yet another embodiment, the invention comprises the method as recited above whereby the method includes recordings that reinforce cross-sensory perception. In a still further embodiment, the invention comprises a method of providing a profile questionnaire. The questionnaire provides questions regarding the user's or individual's sexual history, nature of sexual experiences, preferences, likes and dislikes, beliefs, and the user's or individual's concerns and/or issues regarding sex. In a more preferred embodiment, the profile questionnaire also comprises questions that rate sexual sensitivity of different parts of the human body. In one embodiment the profile questionnaire is reviewed by the subject. In an alternative embodiment, the profile questionnaire is reviewed by another individual. In a preferred embodiment, the profile questionnaire is presented in an editable format, the editable format selected from the group consisting of a book, a graphical user interface (GUI), a voice-recording system, an interactive format, a touch-sensitive format, and any combination thereof. In another preferred embodiment, the method further comprises a step of requesting the human subject complete the profile questionnaire.

In a more preferred embodiment, the profile questionnaire also comprises questions that reveal the subject's capacity for intimacy. In a most preferred embodiment, the profile questionnaire comprises questions comprising topics selected from the group consisting of interests, preferences, goals, previous experience, current knowledge, questions that reveal the subject's capacity for intimacy, and ability and satisfaction regarding sex and intimacy.

In another more preferred embodiment, the method further comprises the step of recording the completed profile questionnaire on a recordable digital medium. In a more preferred embodiment, the method further comprises the steps of reviewing the completed profile questionnaire and comparing the profile questionnaire to a database comprising completed profile questionnaires. In another more preferred embodiment, the method further comprises a step of wherein the completed profile questionnaire is reviewed by the human subject. In another more preferred embodiment, the method further comprises a step of wherein the completed profile questionnaire is reviewed by another individual. In a most preferred embodiment the other individual is selected from the group consisting of a sexual partner, a prospective sexual partner, a clinician, a nurse, a psychologist, a sex therapist, a physical therapist, and a sexologist.

In another embodiment, the video recording comprises a linear video recording. In a more preferred embodiment, the linear video recording is selected from the group consisting of live action, animated illustrations, and still images, the live action selected from the group consisting of hand drawn 2D animation, photo generated 2D animation, computer generated 2D animation, computer generated 3D animation, claymation, go-motion, puppetry, staged acting, and any combination thereof.

In one preferred embodiment, the method comprises an 8-step method of experiential training, the 8-step method comprising the steps of (i) presenting the human subject with a profile questionnaire, wherein the step is performed using a recordable and playable medium and a first interactive software program; (ii) presenting the human subject with a summary of the objectives of the method, wherein the step is performed using a recordable and playable medium and wherein the step comprises images, audio, and video; (iii) presenting the human subject with a demonstration of the method, wherein the step is performed using a recordable and playable medium and wherein the step comprises images, audio, and video; (iv) presenting the human subject with an explanation of the method, wherein the step is performed using a recordable and playable medium and wherein the step comprises images, audio, and video; (v) stimulating the human subject using a second interactive software program, wherein the step is performed using a recordable and playable medium and wherein the step comprises images, audio, and video; (vi) testing the human subject using a third interactive software program, wherein the step is performed using a recordable and playable medium and wherein the step comprises images, audio, and video; (vii) reinforcing the human subject's experiences of steps (i), (ii), (iii), (iv), (v), and (vi) using a combination of steps selected from the group consisting of steps (i), (ii), (iii), (iv), (v), and (vi); (viii) rewarding the human subject, wherein the step is performed using a recordable and playable medium and wherein the step comprises images, audio, and video; (ix) presenting guided visualizations to the human subject, wherein the step is performed using a recordable and playable medium and wherein the step comprises audio; (x) presenting guided lovemaking to the human subject, wherein the step is performed using a recordable and playable medium and wherein the step comprises audio; and (xi) presenting the human subject a recording, the recording selected from the group consisting of the audio of steps (ix) and (x), the steps resulting in experiential training of the human subject.

In yet another embodiment, the invention comprises the above recited method and further comprises providing a pharmaceutical composition, the composition selected from the group consisting of amphetamines, catecholamines, amino acids, peptides including neuropeptides and the like, endorphins, caffeine, nicotine, selective serotonin reuptake inhibitors (SSRIs), phosphodiesterase inhibitors, ion channel blockers, calcium ionophores, an agonist of the said pharmaceutical compositions, an antagonist of said pharmaceutical compositions, and the like, and a suitable pharmaceutical carrier, whereby the pharmaceutical composition is ingested by the individual and modifies at least one neural and/or muscle tissue activity of the individual thereby resulting in improved experiential memory. In another embodiment, the pharmaceutical composition comprises naturally-occurring compounds derived from plant, fungal, or bacterial organisms. In a more preferred embodiment, the individual ingests the pharmaceutical composition and the pharmaceutical composition and/or any metabolic derivatives results in changes in the individual's sexual response, sexual experience, and ability to participate in a satisfying sexual experience.

In an additional embodiment, all of the above training images, recordings, and devices are available on a computer server, the server being accessible to the subject or individual through the World Wide Web Internet system.

In another embodiment of the invention, the invention comprises a kit, the kit comprising at least one booklet, at least one video recording, and at least one audio recording. The booklet comprises various images of the human body and partial views thereof; the booklet further comprising descriptions of the physical and emotional implications of under- or over-stimulation of each subject's sensual area; the areas of the genitals that are stimulated in different ways via oral and/or manual stimulation, or intercourse; or at different angles, penis to G-spot, penis to cervix, and pubic bone to clitoris. The video recording comprises individuals who demonstrate pelvic move exercises followed by demonstrating applications of various pelvic moves in various sexual positions while actually having intercourse. Some sequences may include graphics overlaying live bodies to show angle of penis relative to G-spot or cervix in a certain position. The audio recording comprises a narrative that instructs the subject or subjects to perform any of the activities in training materials and a subliminal and/or non-subliminal sound to provide brainwave and/or cross-sensory training.

In a yet further embodiment, the invention can be used by an individual to improve their relationship with another individual, including, but not limited to, improved emotional responses and emotional interactions, improved energetics of an individual's body, improved absorption with another individual, improved intimacy, and improved emotional mental components in a relationship or other social interaction.

In an alternative embodiment, the invention provides a kit comprising a method for training a human subject, the training resulting in an improved sensual and sexual fulfillment for the human subject, the kit comprising at least one audio recording recorded on a recordable and playable medium, at least one video recording recorded on a recordable and playable medium, at least one interactive software program, and at least one permanent media storage and retrieval medium. In one preferred embodiment, the recordable and playable medium is selected from the group consisting of an audio tape, a video tape, a compact disc (CD), a CD-ROM, a DVD, a DVD-ROM, an MP3 recorder, a digital audio file recorder, a digital video file recorder, a hard disk drive device, a laser disc, a computer memory chip, nanotechnology systems (such as, but not limited to molecular-scale storage devices or atom-scale storage devices), other optical recording and storage devices. In another preferred embodiment, the permanent media storage and retrieval medium is selected from the group consisting of an audio tape, a video tape, a compact disc (CD), a CD-ROM, a DVD, a DVD-ROM, an MP3 recorder, a digital audio file recorder, a digital video file recorder, a hard disk drive device, a laser disc, a computer memory chip, nanotechnology systems (such as, but not limited to molecular-scale storage devices or atom-scale storage devices), other optical recording and storage devices. In a further preferred embodiment of the invention, the training further results in an improved intimacy for the human subject. In another most preferred embodiment the kit comprises an 8-Step Method of experiential training.

In another embodiment, the invention provides a training system comprising a permanent media storage and retrieval medium, the system having access to a data storage facility and further comprising stored in the data storage facility, a software program and at least one database to implement a training method wherein the software program comprises procedures to effect a training method as disclosed herein. In a preferred embodiment the permanent media storage and retrieval medium is selected from the group consisting of an audio tape, a video tape, a compact disc (CD), a CD-ROM, a DVD, a DVD-ROM, an MP3 recorder, a digital audio file recorder, a digital video file recorder, a hard disk drive device, a laser disc, a computer memory chip, nanotechnology systems (such as, but not limited to molecular-scale storage devices or atom-scale storage devices), other optical recording and storage devices.

In a yet other embodiment, the invention provides a computerized training system comprising a data processing unit, random access volatile memory available to the data processing unit, an audio device to audibilize output from the computerized system to be heard by the user, and a visual display device to visualize output from the computerized system to be seen by the user, the computerized system having access to a data storage facility and further comprising stored in the data storage facility, a software program and at least one database to implement a training method wherein the software program comprises procedures to effect a training method as disclosed herein. In one preferred embodiment, the audio device and the display device are in electronic communication with the data processing unit and the data storage facility. In another preferred embodiment, the audio device and the display device are in wireless communication with the data processing unit and the data storage facility. In a still further preferred embodiment, the audio device and the display device are in optical communication with the data processing unit and the data storage facility. In a more preferred embodiment the computerized training system comprises a training method that comprises an 8-Step Method of experiential training.

### DESCRIPTION OF THE TABLE

Table 1 shows how the many components, embodiments, and steps of the invention can be combined to create products that can be targeted to particular population segments. The population segments can be distinguished by age, sexual orientation, and country of origin. The products listed are exemplary and do not limit the scope of the invention.

### BEST MODE OF THE INVENTION

The embodiments disclosed in this document are illustrative and exemplary and are not meant to limit the invention. Other embodiments can be utilized and structural changes can be made without departing from the scope of the claims of the present invention.

As used herein and in the appended claims, the singular forms “a,” “an,” and “the” include plural reference unless the context clearly dictates otherwise. Thus, for example, a reference to “an image” includes a plurality of such images, and a reference to “a recording” is a reference to one or more recordings and equivalents thereof, and so forth.

In one embodiment, the present invention is a method of training an individual so that the individual has a more fulfilling, more intimate and more sensual sex life. More particularly the method of training is skill training. Skill training can include, but is not limited to, training for operating machinery, training for performing surgical procedures, training for operating a vehicle, training for teaching a method, training for performing in a public and/or private performance, and the like. Additional skill training applications include: Sports and Recreation (such as; Golf, Tennis, Sailing, Dance, Surfing, Snowboarding, Skiing, etc.), Personal Growth, Exercise and Energetic Arts (such as Meditation, Yoga, T'ai Chi, Qigong, Pilates, Martial Arts, and the like), Communication Skills (such as Understanding and Communicating with the Opposite Sex, Public Speaking, Sales Training, Management Training, and the like). In one embodiment the method of training is experiential training.

The present invention has a clearly established utility as being of use for a subject to have an improved, more fulfilling, more intimate, and more sensual sex life. Such improvements can result in a more productive and healthy person and reduce societal costs due to depression, loss of productivity, reduced healthcare costs, and the like. In addition, sexual activity can be likened to a form of sports activity, wherein significant amounts of metabolic energy are expended and muscle is adapted to be more metabolically efficient, thereby improving the health and fitness of a human subject.

The disclosed invention of experiential training is also of use in the additional skill training applications as recited above. The examples recited herein for training an individual to have an improved, more fulfilling, more intimate, and more sensual sex life can be used to provided similar training schemes, content, and methods that are appropriately designed and chosen for the additional intended skill training applications. Such methods, kits, and systems can include the equipment that is appropriate for the skill training application, such as, but not limited to, hardware that stimulates a physical response of a human subject, biofeedback equipment, golf clubs or a golf club simulator, racquets, surfboards, snowboards, skis, various simulatory devices of the aforementioned equipment, and the like.

The invention as applied to Lovemaking Training, applies the best of what is known about how people learn to the best of what is known about magnificent lovemaking, to create an unprecedented and effective product that will revolutionize the way people learn about sex and intimacy. The method of training comprises at least four steps, the steps comprising the following activities: the individual looking at diagrams depicting sexual energetics, verbal and/or physical intimate communication, sexual organs and/or sexual positions; listening to segments of audio having recorded sounds, including subliminal and/or non-subliminal sounds that can subtly affect the individual's brain wave pattern; watching a video recording on a visual display using (VDU), the video recording having images of individuals engaged in intimacy-building and/or sexual enhancement skills; and interacting with computer content. The steps can be repeated at least once. In a preferred embodiment the steps are repeated selected from the group consisting of, once, twice, thrice, four times, five times, six times, seven times, eight times, nine times, ten times, eleven times, twelve times, thirteen times, fourteen times, fifteen times, sixteen times, seventeen times, eighteen times, and nineteen times. In addition, the steps can be repeated at least about twenty times, at least about twenty five times, at least thirty times, at least about forty times, and at least about fifty times. In general there is no limit to the number of times that a step can be repeated.

The invention includes a combination of linear media, interactive media, game play, neuroacoustic technology and neurolinguistic programming specifically designed and integrated as a method for truly effective lovemaking training. This methodology makes the lovemaking training experiential.

The reason for making lovemaking training experiential is to provide the participant with a truly effective and somewhat effortless way to take into experiential memory (mental, emotional, energetic, and physical memory), specific lovemaking knowledge and skills that can then be applied effortlessly in actual lovemaking.

Experiential lovemaking training can provide a response conditioning process that establishes associations within the adaptive unconscious that enhance lovemaking. The Training can provide repeat experience between these associations. These associations include but are not limited to thoughts, emotions, behaviors, brainwave patterns, spoken information, illustrated ideas, sexual images, sexual scenarios presented as video sequences (created with live action, two-dimensional and three-dimensional graphics), sounds, words, and music. Through experiential lovemaking training the trained person gains experiential memory of these positive associations. Through a series of training sessions (over time) these positive associations become part of the trainee's adaptive unconscious and as a result these positive associations can have a positive influence on the trainee's real life lovemaking behavior and experience. Participation in experiential lovemaking training can result, over time, in these conditioned response associations becoming part of the trainee's adaptive unconscious. During actual lovemaking the thoughts, feelings, and brainwave patterns that are associated with various aspects of sex in the adaptive unconscious (as the result of experiential lovemaking training) then become associated with the sights, sounds, smells, tastes, touch sensations, movement and all related sexual behaviors of actual lovemaking. When this happens sex positive associations in the adaptive unconscious and actual sex are mutually reinforcing, making it increasingly possible for the trained person to have a satisfying sexual experience.

In one embodiment, the training method can be assembled into a variety of products that can be referred to as Experiential Lovemaking Training (ELT) methods and kits. The products can comprise, for example, but are not limited to, a booklet, a leaflet, a training manual, a training guide, audio tape, audio CD, video tape, compact-disk read-only-memory (CD-ROM), digital versatile disk or digital video disk (DVD), a diskette, a “pen-drive” or a “memory key”, and the like. The training method can also be supplied to, and used by, a subject using streaming video, streaming audio, other online means, or the like. In addition, other means for delivery of the training methods can include, but are not limited to, wireless electromagnetic radiation systems (such as radio, microwave transmission), land-based electronic systems (such as digital cable, telephone lines, power lines), optical photon-based system (such fiber-optical systems as disclosed in U.S. Pat. No. 7,023,705), and the like.

The method of training and the kit comprising the Experiential Lovemaking Training Products) differ from all other lovemaking training and sex education products on the market to date. They are the first and only sex education and lovemaking training products to work with multiple learning modalities (visual, auditory, kinesthetic) enhanced by neurolinguistic programming and/or neuroacoustic technology, including brainwave entrainment. These products engage an individual in a virtual hands-on lovemaking training experience that is readily applicable to real life. This process also enables self-discovery and growth, and empowers love relationships.

Sex education, lovemaking information, and limited lovemaking training is currently available in the following media formats, such as, but not limited to, magazines, books, audiotapes, audio CDs, MP3 audio files, iP audio (streamed and downloadable), broadcast radio, internet radio, videotapes, DVDs, iP video (streamed and downloadable), and television (broadcast, cable, satellite). Much of the lovemaking information, provided by products in these formats, is useful and some is well communicated. None of the lovemaking training in these formats provides information and training in a way that easily translates into actual lovemaking in real life.

The best lovemaking training currently available is found in live workshops and with sex surrogates. But these sources are expensive and not readily available or acceptable to everyone. In general, lovemaking skills training is not yet widespread because it is not being delivered in a way that makes consumption easy, enjoyable, and truly effective. Current formats of lovemaking training do not readily translate into body memory. People who use books, audios, and videos to develop lovemaking skills must make an extra effort to translate that information into practice during actual lovemaking. This effort is distinctly separate from the consumption of lovemaking information contained in a lovemaking information product. It is an effort that must be made during actual lovemaking. Further, it is this effort that usually stops people from mastering the art of lovemaking.

The invention enables personalized Experiential Lovemaking Training in the privacy of the home, providing informative, entertaining and tastefully erotic content with an experiential training method that is fun to use and highly effective. The method includes, but is not limited to, high resolution linear video, interactive graphics and video, computer driven game-play (audio/video/graphics), neuroacoustic technologies, including brainwave entrainment, neurolinguistic programming, and personalized experience (through personal and couples profiles).

All of these processes are combined in a method that translates ancient sacred sex practices, contemporary psychology, and current sex knowledge into experiential memory (mental, emotional, energetic, and physical memory) for sustainable sexual satisfaction and sexual-spiritual fulfillment. The information provided in this training can be found in books, videos, and workshops but has never been assembled, until the invention was conceived, in any practical, affordable way for adults to effectively use and enjoy. The combination of the different activities and media used in the invention has particular use for the following reasons: 1) the synergistic relationship between all of the training processes/techniques and technologies included in the “Mind-Body Learning System and Methods of Use” or the 8-Step Method can result in a more improved training and learning process and implementation of that training and learning; 2) the application of the “Mind-Body Learning System and Methods of Use” to lovemaking training or the 8-Step Method.

Through this combination and application of “Mind-Body Learning System and Methods of Use” technologies, the methods and kits that comprise the instant invention (also referred to as the Experiential Lovemaking Training Product(s) can engage an individual in multiple learning modalities (visual, auditory, kinesthetic) that is also enhanced by neuroacoustic technologies, including brainwave entrainment. The Experiential Lovemaking Training Product(s) make no distinction for the individual between the consumption of lovemaking information and the translation of that information into experiential memory. The instant invention engages the individual in a virtual hands-on experiential lovemaking training experience that translates to experiential memory and is readily applicable to real life.

Additional applications that can be used with the methods disclosed herein include audible stimuli, such as sound, sensory stimuli, such as touch and haptics, and visual stimuli, such as flashing lights, lights changing intensity, Color Treatment, or the like. Descriptions of how to use Color Treatment are well known to those of skill in the art and are included in holistic therapy and the like (for example, International Cyber Business Services, Inc. (ICBS, Inc.) see world wide web at holisticonline.com ).

### Absorption

When pertaining to lovemaking, this is the process or social interaction of having the attention, sensations, emotions and energy of an individual completely engaged in the attention, sensations, emotions and energy of another individual or lover. It can also mean to be “present” to the sensations, emotions, energy and activity of lovemaking without any other distracting thoughts or behaviors. Absorption can also mean to be “one” with your lover. Other definitions of “absorption” are described in both general and specialist dictionaries.

Graphical Interface for Interactive Content Navigation and User Participation

The invention uses a graphical user interface that makes user options obvious and user control intuitive. Graphical user interfaces provides a user the ability to interface with a software program and the like. Design, construction, and use of graphical user interfaces are well known to those of skill in the art. This interface provides a variety of ways and segments in which an individual can participate with components of the invention such as, but not limited to, Mastery Track, Exploratory Track, Refresh Track, Subject Overview, Product Overview, Section Overview, View Linear Segments, Just Listen, Play the Game, Create Personal Profile, and the like.

### Fibonacci Formula

The Fibonacci sequence is generated by setting a₀=1, a₁=1, and then using the recursive formula

aₙ=aₙ₋₁+aₙ₋₂

to derive the rest. Thus the Fibonacci sequence begins: 1, 1, 2, 3, 5, 8, 13, 21, 34, . . . . In addition, there is an exact formula for the n-th term:

aₙ=[Phiⁿ−(−1/Phi)^{m}]/Sqrt[5]

where Phi=(1+Sqrt[5])/2 is the golden mean.

### Content of the Method of Training

The interactive product line can consist of at least three program series (that can be named “Product Families”) comprising at least ten training modules each. Topics for the series can be, for example, but not limited to:

1) How to transform ordinary sex into fabulous lovemaking.

2) Self-healing of sexual dysfunction and sexual trauma.

3) Sexual-spiritual fulfillment and transcendent sex. Program content can be drawn from ancient sacred lovemaking traditions, transpersonal and relationship psychology, and modern sexuality research. It is organized and communicated in ways that are accessible and meaningful to the western mind. For these interactive programs we will add the best of brainwave technology and training to enhance not only learning of the material, but also the actual experience of lovemaking. To date, no one has integrated this information or conveyed it via interactive programming to a broad public.

Truly fulfilling sex is supported by knowledge and skill at building and sustaining high levels of arousal and circulating and releasing sexual energy. However, research indicates that the best predictor of intense sexual pleasure, and even ecstatic or transcendent sex, is the ability to become fully absorbed in the moment. Absorption, which can be measured and which one can learn to increase, is also associated with peak sexual arousal. The keys to increasing absorption are cross-sensory training and brainwave management.

Thus, the best and most effective interactive sex education can offer two things:
1) Personalized information, interpersonal tools and skills training delivered in a unique way that is emotionally engaging, entertaining, and memorable, and
2) Training in the management of brainwave states and internal sensory experience in enjoyable ways to increase absorption during lovemaking.
   This combination enables the individual to quickly integrate knowledge through both hemispheres of the brain into body memory and body habit for spontaneous, deeply fulfilling lovemaking.

The training products can be delivered on multi-functional DVDs and CDs. When the DVD is played on a computer, full interactivity is enabled. When the computer and DVD are combined with the internet, the disc interface will update allowing interaction with a database of ancillary information and services. This can also enable both synchronous and asynchronous interactivity between individuals and possible mentors or coaches.

Each DVD may also be used in a DVD player to view video sequences in a more comfortable and intimate environment and to listen to audio segments during lovemaking to help individuals integrate their learning in a natural, unobtrusive and pleasurable way. Some brainwave and cross-sensory training can be conveyed via audio CD, which individuals can use apart from the actual lovemaking experience.

The second program series (on self-healing of sexual dysfunction and sexual trauma) can include guided exercises for somatic release of trauma and rhythmic light and color stimulation projected through the computer screen to assist in the release of emotional blocks. A second tier of service, which is optional to the consumer, and adjunct to this series, can be live one-on-one sex therapy via internet voice and video and desktop communication.

Each individual can receive a personal protocol based on answering a set of personal questions. The personal protocol can guide the individual through the program segments and components.

A segment or step in a method of training can be a topic area of content and/or information (for example, Closing the Gap in Masculine and Feminine Arousal Rates, Erotic Touch, Male Multiple Orgasm before Ejaculation, Extended Female Orgasm, etc.) There can be at least ten program segments. A component can comprise a delivery mechanism (i.e., interactive computer CD-ROM, DVD-ROM, DVD, CD, MP3 files, or on-line activity, workbook activities for those without computers, DVD, audio CD, or MP3 players, and future audio and video display and interactive media technologies).

Each training product can use the Eight-Step Method of experiential lovemaking training, as disclosed below, and is designed to help the trainee achieve specific life skills goals. To achieve a life skill goal the trainee must accomplish one or more life skill objectives. To accomplish any life skill objective (specified within the training product) the trainee must follow an eight-step process comprising at least one training module. This eight-step process is the exemplary method of training herein described as the invention. Each step in the training module is described as a segment. Therefore, there can be at least eight steps or segments to every training module and the number of training modules in a product are determined by the number of objectives that a trainee must accomplish to achieve the life goal (or goals) specified as the purpose of the training product.

A training module in this method of training can be focused on topic area of content/information (for example, Closing the Gap in Masculine and Feminine Arousal Rates, Erotic Touch, Male Multiple Orgasm before Ejaculation, Extended Female Orgasm, etc.).

A component is a delivery mechanism, including but not limited to, interactive DVD, linear DVD, Audio CD, on-line activity, workbook activities. Each training module in an eight-step training module uses one or more these components.

A video recording and an audio recording can be recorded in any format, such as, but not limited to, a CD-ROM, a digital video disc (DVD), a VHS tape, other magnetic tape formats for recording data, video and audio, a laser disc, a computer data storage disc, a computer memory chip, hard disk drive devices, nanotechnology storage systems (such as, but not limited to, molecular-scale storage devices, atom-scale storage devices), other optical storage devices, or the like. Furthermore, a video recording can be viewed using any format, such as, but not limited to, a viewing device such as visual display unit (VDU), a light emitting diode (LED) screen, a liquid crystal display (LCD) screen, a reflecting screen, a virtual reality display screen, or the like. The video recording can also be in a three-dimensional (3D) format that can be viewed using 3D glasses. 3D glasses can be glasses having paired optical filter lenses that have red and green optical filter lenses or that have vertical and horizontal polarizing optical filter lenses and the video recording created and recorded using the appropriate system for such viewing. Furthermore, an audio recording can be heard using any audio display format, such as but not limited to audio CD player, MP3 player, DVD player, computer, or the like, attached to either speakers, headphones or both, or the like. The image can be presented to the human subject for a pre-determined time period. In the alternative, the human subject can control the time period to have the image presented. The time period can be from about 1/60 of a second to about 300 minutes. The time period can be about 1/60 of a second, 1/30 of second, ⅙ of a second, ½ of a second, one second, two seconds, five seconds, ten seconds, twenty seconds, thirty seconds, forty seconds, fifty seconds, one minute, two minutes, three minutes, five minutes, seven minutes, ten minutes, fifteen minutes, twenty minutes, thirty minutes, forty minutes, fifty minutes, one hour, two hours, three hours, and about five hours.

The video recording can be presented to the human subject for a pre-determined time period. In the alternative, the human subject can control the time period to have the video recording presented. The time period can be from about 1/60 of a second to about 300 minutes. The time period can be about 1/60 of a second, 1/30 of second, ⅙ of a second, ½ of a second, one second, two seconds, five seconds, ten seconds, twenty seconds, thirty seconds, forty seconds, fifty seconds, one minute, two minutes, three minutes, five minutes, seven minutes, ten minutes, fifteen minutes, twenty minutes, thirty minutes, forty minutes, fifty minutes, one hour, two hours, three hours, and about five hours.

The audio recording can be presented to the human subject for a pre-determined time period. In the alternative, the human subject can control the time period to have the audio recording presented. The time period can be from about 1/60 of a second to about 300 minutes. The time period can be about 1/60 of a second, 1/30 of second, ⅙ of a second, ½ of a second, one second, two seconds, five seconds, ten seconds, twenty seconds, thirty seconds, forty seconds, fifty seconds, one minute, two minutes, three minutes, five minutes, seven minutes, ten minutes, fifteen minutes, twenty minutes, thirty minutes, forty minutes, fifty minutes, one hour, two hours, three hours, and about five hours.

### The Eight-Step Method

The methods and kits comprising the Experiential Lovemaking Training Product(s) teach and train product users to achieve sustainable lovemaking satisfaction that is also the foundation for sexual spiritual fulfillment. The advanced Experiential Lovemaking Training Product(s) methods and kits teach and train users to participate in lovemaking in a way that transforms sexual energy into spiritual awakening and transcendent states of consciousness.

The method of Experiential Lovemaking Training Product(s) comprises training that is provided in such an engaging, personal, and vivid way that it can be recalled as clearly as a real life experience. Over time, through repeat experience and conditioning this kind of learning/training becomes part of a trainees adaptive unconscious. This allows the trainee to use the information and/or skill without a conscious effort; similar to playing a musical instrument, riding a bicycle, or driving a car.

Each method and kit comprising a product is organized according to Lovemaking Goals and Objectives, Knowledge and Skills. Understanding Lovemaking Goals and Objectives provides a context for Training. The training is designed to teach and/or train knowledge and skills.

This 8 Step Method of experiential training can include:

Typical Training Techniques Applied to Lovemaking Training
Audio/Video/Text including
   Introduce
   Demonstrate
   Explain

Training Techniques applied to Experiential Lovemaking Training
Personalization (software response to user's or individual's answers to personal questionnaire)
Brainwave entrainment (music, sounds (subliminal and/or non-subliminal), sound processing)
Neurolinguistic Programming (words and statements)
Emotional engagement (story, characters, setting, art direction, lighting, cinematography, editing, visual effects, music and sound effects)
Simulation and testing through game play
Training reinforcement (audio only) including
   Guided Lovemaking
   Guided Visualizations
   Music/Audio to enhance lovemaking.

We have found that the following premises contribute to understanding the invention:
1. Music and sound (subliminal and/or non-subliminal) can cause brainwave entrainment.
2. Brainwave entrainment processes can teach people to engage brainwave patterns at will and subconsciously.
3. Brainwave entrainment can be used to increase learning and to enhance lovemaking.
4. Neurolinguistic Programming can be used for lovemaking skills training.
5. Game-play can approximate lovemaking simulation,
6. Personal profiles enable personalized training.
7. Personalized training is more effective than non-personal training.
8. Empathetic relations with characters and stories can be used to evoke emotional energy.
9. Music can be used to evoke emotional energy.
10. Artistic visuals can be used to evoke emotional energy.
11. Color can be used to evoke emotional energy, for example, Color Treatment.
12. Emotional energy can be used to enhance learning and make training more experiential for the subject.
13. All of the above, together, make training more experiential.
14. Experiential training results in experiential memory.
15. Experiential memory becomes part of the adaptive unconscious.
16. Lovemaking Skills must become part of adaptive unconscious to be used effectively in life.

To maximize the effectiveness of this teaching and/or training the invention provides an eight-step training method. These steps can both teach and condition a subject or trainee to think, feel, and behave in ways that support mutual satisfaction during lovemaking. All eight steps can be combined to make the training experiential. Each step reinforces the learning and training of each other step. Some steps involve more left brain participation (more cognitive). Some steps involve more right brain participation (more emotional and/or sensory). Some steps involve dual hemisphere participation somewhat equally (both mental and emotional). Some steps include brainwave entrainment to enhance the learning/training experience. Some steps include brainwave entrainment to produce states of mind that enhance lovemaking. All steps can use engaging media to enhance the users ability to recall information and skill. The interactive interface for each product allows an individual to either follow the track prescribed by the product (in response to the individual's evolving profile) or to select a Lovemaking Goal, then select a related lovemaking objective, and then follow or select from the eight steps provided to train the user to accomplish the selected lovemaking objective. Therefore, for every lovemaking objective there is a series of eight steps. When an individual successfully completes all eight steps the knowledge and skill necessary to accomplish the lovemaking objective will be theirs to use without conscious effort.

The combination method of all eight steps is termed a “training module” and each step is termed a “training segment”. To maximize the learning and/or training experience the individual can be guided to initially take the eight steps in the order presented below.

The eight steps of the experiential training method of the invention are exemplified as follows.

Step 1. The Personal Profile/Couples Profile: (Computer) The profile questionnaire starts at the beginning of the product and continues at the beginning of each 8 step training process. The trainee also has the option to complete the questionnaire all at once. The questionnaire operates on Windows and Macintosh computers and can be accessed via DVD-ROM and on-line. Profiles completed on-line can be downloaded and uploaded.

Step 2. Summary: (Computer and/or DVD video player) This is a quick overview of the lovemaking objective and the knowledge and skill(s) needed to be able to accomplish the lovemaking objective. These segments include video, sometimes graphics and have soundtracks that include a narrator and audio/music for brainwave entrainment to enhance an individual's learning ability.

Step 3. Demonstration/Explanation: (Computer and/or DVD video player) This is most often linear, but the explanation can include some interactive exploration. Both include soundtracks with dialogue, narrator and music/audio for brainwave entrainment to enhance learning ability. Some narration will be scripted for neurolinguistic programming. Color Treatment may also be applied to enhance learning. All linear segments of the Demonstration/Explanation can be viewed on DVD video. All interactive segments of the Demonstration/Explanation utilize a computer or the like for operation.

Step 4. Simulation and Testing through Interactivity or Game-Play: (Computer Only) This engages the trainee in using what was taught and tests the trainee's knowledge and understanding. It includes brainwave entrainment audio/music to enhance lovemaking, NLP and Color Treatment. A computer or the like is used for operation.

Step 5. Reinforcement/Reward Video: (Computer and/or DVD video player) This engages the trainee's emotions in a memorable scene that reinforces what was taught. Each scene (for each training module) helps tell a story that becomes a context for understanding the purpose and value of what is being taught. These segments can include brainwave entrainment audio/music to enhance lovemaking. Color Treatment is also used to give the scene emotional impact and make the experience more memorable.

Step 6. Guided Visualizations: (CD audio or MP3 files) These are audio only stories accompanied by brainwave entrainment music/audio. The stories engage the imagination of the trainee in a process designed to increase “absorption” and “sensualization” skills. The brainwave entrainment evokes states of mind that are conducive to intimate lovemaking. The narrator will also use neurolinguistic programming to reinforce positive lovemaking messages. These audio segments can be used comfortably and easily in any location. They are best heard through quality headphones but they also work well for couples using an audio speaker system.

Step 7: Guided Lovemaking: (CD audio or MP3 files) These are audio only coaching sessions for lovemaking. Lovers listen to these segments together while making love. Narration with neurolinguistic programming is used to guide lovers through a lovemaking process. Brainwave entrainment audio/music is also used to evoke brainwaves that enhance lovemaking.

Step 8: Lovemaking Support Music. (CD audio or MP3 files) Uses extended versions of the brainwave entrainment audio/music from the soundtracks of steps 6 & 7. This music/audio helps lovers to get into a state of mind that enhances lovemaking and can help them recall their lovemaking training without being interrupted in any way by coaching.

The method and kit can also further comprise additional components of the steps or additional steps selected from the group consisting of HRV and other biofeedback systems throughout the method in any one of the steps or as an additional step, Feng Shui Design Principles, and Color Treatment throughout the product to maximize results.

In the alternative, each step or segment can progress with increasing levels of explicitness. Examples for the first program can include
1. A Segment on “Touch” may begin with diagrams of masculine and feminine sexual energy flow, descriptions of evolutionary reasons why women are generally more sensitive to touch and men need firmer touch, etc. It will then progress to videos of nude couples demonstrating various types and methods of touch with explanations of the sympathetic/parasympathetic nature of arousal, demonstrating an erotic “connect the dots” game, and on to sensual massage and eventually explicit sexual massage. Then an audio CD will guide the individuals in a “You Try it Now” session.
2. A Segment on “Pelvic Moves” might start with diagrams of “genital reflexology” (and descriptions of the physical and emotional implications of under- or over-stimulation of each area) and the areas of the genitals that are stimulated in different ways (for example, via oral and/or manual stimulation, or intercourse) or at different angles (for example, penis to G-spot, penis to cervix, pubic bone to clitoris, etc.). Then live models, either naked, partially naked, naked and painted, in body suits, or the like, will demonstrate pelvic move exercises while standing (for the viewer to follow along), followed by demonstrating applications of various pelvic moves in various sexual positions while actually having intercourse. Some sequences may include graphics overlaying live bodies (to show for example, angle of penis relative to G-spot or cervix in a certain position). Again, an audio CD can guide the individuals in a “You Try it Now” session.

Benefits of increasing levels of explicitness can be a follows: i) both parties get useful information before getting aroused, so there is no disjointedness in erotic sequences, once they begin, as is often found in erotic sex ed videos; ii) women who may be less comfortable with explicit sequences get to gradually warm up to them and justify them in their own minds; iii) men and women who like explicit sequences get what they want, but don't get too aroused too soon, i.e., without the underlying information to put the explicit demonstrations to the best use.

### The Experiential Lovemaking Kit

Experiential Lovemaking Training Product(s) can be packaged as a box-set of multifunctional DVDs and audio CDs. The DVDs comprise hybrid operating system software and play on Windows and Macintosh computers for interactive participation and linear video play. These DVDs can include links to an active online database of information and on-line services. On-line services enable synchronous and asynchronous interactivity between individuals and possible mentors or coaches. The DVDs also play on standard DVD players for menu driven linear view. The audio CDs in the box-set play on all audio CD players. This audio can also be available on-line for product owners to download to MP3 players. All products can default to spoken English, with spoken Spanish and French and German options.

The Experiential Lovemaking Training Product(s) can combine the emotional power of motion pictures with the personal impact of interactivity to provide truly experiential sex education for individuals and couples. This training can teach healthy, uplifting and sustainable sexual pleasures for both men and women in a manner that is simultaneously engaging, entertaining, elegant, and tastefully erotic.

Components of the kit may include but are not limited to:

Media components that can include:
Interactive Media (for personal profile)
Audio/Video
   Lead into interactive questionnaire
   Summary
   Demonstration/Explanation
   Reinforcement and Reward
Interactive media and/or game play (for simulation and testing)
Audio only
   Guided Visualization
   Guided Lovemaking
   Lovemaking Support

Training techniques provided in the kit can include:
Personalization (software response to questionnaire)
Brainwave entrainment (music and audio, subliminal and/or non-subliminal)
Neurolinguistic Programming (words and statements)
Emotional engagement (story, characters, setting, art direction, lighting, cinematography, editing, visual effects, music and sound effects)
Simulation through game play
Simulation and game play with biofeedback
Training reinforcement (audio only)
   Guided Lovemaking
   Guided Visualizations
   Music/Audio to enhance lovemaking

### Parts and Pieces of the Box Set

The training techniques and media components of Experiential Lovemaking Training Product(s) are integrated within the parts and pieces of the Experiential Lovemaking Training Product(s) box set kit. The parts and pieces of this box set kit include:
DVD/DVD-ROMs
Audio CDs (will CD audio and MP3 files)
Workbook (Text, Graphics, Photos)

### Product Families

Products targeted to different population segments can be created to provide experiential training for other skills. Such population segments can be by, for example, country or region of origin, such as, but not limited to, English, Japanese, Chinese, French, German, Italian, Spanish, Portuguese, Russian, Indonesian, Austronesian, Latin American, Indo-European, Indo-Iranian, Uralic, Altaic, Dravidian, Niger-Kordofanian African, Nilo-Saharan African, Khoisan African, Arabian, Austroasiatic, Sino-Tibetan, or the like, by age, by sexual orientation, by prior skill set, by Grade Level, or the like.

The embodiments listed below can pertain to the three Product Families (see Table 1). These product families are: 1) Experiential Lovemaking Training (about 12 embodiments)

2) Advanced Experiential Lovemaking Training (about 10 embodiments) and
3) Healing Sexual Trauma and Psychologically Based Dysfunction (about 8 embodiments).
Product Family 1 (Experiential Lovemaking Training) has seven Products: 1) Heterosexual Adults (all ages); 2) Heterosexual Adults (ages 18-26); 3) Japanese Adults (all ages); 4) Lesbian Adults (all ages); 5) Gay Adults (all ages); 6) Experiential Lovemaking Education for Teens (to help teens get on a positive track towards a healthy love life); 7) Experiential Lovemaking Training for Married Christians; and the like.
   All 12 embodiments (below and shown on Table 1) can be made for each of these seven potential products in the Product 1 Family resulting in a total of 60 embodiments.
Product Family 2 (Advanced Experiential Lovemaking Training), has two products: 1) is for all adults; 2) for Japanese Adults. These products have the same embodiments as Product Family 1 except: It only has a One-Player Game and that game can use Biofeedback device. Therefore embodiments 10, 11 (below) do not apply to Product family 2. The total embodiments for this product family equal 10. (See Table 1).

Product Family 3 (Healing Sexual Trauma and Psychologically Based Dysfunction) is for adults of all ages and has the same embodiments, as Product Family 2 except it does not provide Guided Lovemaking Training. Therefore Product family 3 does not include embodiments 3, 4, 10, 11 (below). Like Product Family 2, Product Family 3 offers only a One-Player Game and that game uses a Biofeedback device. The total embodiments Product Family 3 equal 8.

### Age and Language Options

Although the training and information for each product is essentially the same, the script, the models, music, art direction, packaging, and some information can be specific to each age group. Each Product can link to related age-specific information and services on-line. Also, each Product can have an age-specific infomercial for TV and DVD, and internet streaming distribution. In addition to English, Spanish, French and German (spoken language options) any or all of these products may be produced in other languages for other foreign markets. In countries where the age of consent differs from that in the US, user and target ages can be extended to that age where appropriate.

### Exemplary Embodiments

Any media component or components of the Experiential Lovemaking Training Product(s) that can be packaged and sold separately is considered an embodiment of the Experiential Lovemaking Training Product(s). The following is a list of these embodiments.

### 1) Personal and Couples Profile

This computer-based profile questionnaire is a product that can be used and sold separately from the box set kit. The profile questionnaire can be accessible on-line and can also be packaged on CD-ROM or DVD ROM with on-line options. Companies such as matchmaking services can also license the profile questionnaire. Eventually, the profile questionnaire may be published in print.

### 2) Guided Visualizations

These audio files take the listener through an imagined experience of intimate lovemaking designed to increase “absorption” and “sensualization”. The Narrator is accompanied by music and sound effects (subliminal and/or non-subliminal) for brainwave entrainment. The brainwave frequencies evoked by the sound track can enhance lovemaking. These guided visualizations may be like erotic short stories on CD or MP3 players. They can be sold as audio CDs as downloadable MP3 Files and also can be used for various types of radio, such as, but not limited to, traditional airway broadcast, satellite, internet). The verbal content of these stories may eventually be published in print.

### 3) Guided Lovemaking

Step 7 of the 8 Step Method uses audio files (such as recorded on audio CDs or as downloaded MP3 files) for guided lovemaking training. These files include a Narrator that provides real-time guided lovemaking. The Narrator is accompanied by music, sounds and sound processing for brainwave entrainment. The entrainment is designed to induce brainwave patterns that enhance lovemaking. Lovers can listen to these audio files and be guided in their lovemaking while invoking a mutual state of mind that enhances their lovemaking. The verbal content of this guided lovemaking may be published in print.

The 8^{th} step of the 8 Step Method provides just the music and sound effects of step 7 to be used to enhance and support unguided lovemaking.

The audio files of both Steps 7 and 8 can be combined as a single product to be distributed on CD and/or sold as downloadable MP3 files.

### 4. Guided Visualizations Plus Guided Lovemaking

Combines embodiments 2 and 3 into a single product.

### 5. Linear Video

Each training module includes cinematic linear video segments that introduce, demonstrate, explain, and reinforce lovemaking skills. These linear segments (Summaries, Demonstrations & Explanations, Reinforcement/Rewards) can be edited together into a single video per training module. In addition, the edited videos for each training module can be edited together into one long-form lovemaking training video. This long-form lovemaking training video can be sold on DVD, VHS tape, and can be broadcast or downloaded via the Internet and broadcast via television distribution systems (such as traditional airway broadcast, cable, satellite).

In addition, the edited videos for each training module can be used as segments of one or more other television program(s).

### 6. Profiles and Linear Videos

Embodiment 4 combines into one product on DVD ROM (for computer) the Personal and Couples Profile (embodiment 1) with the linear videos (embodiment 5).

### 7. One-Player Game

Each Experiential Lovemaking Training Product(s) module within the 8 Step Method includes a segment of a one-player game. These segments can be combined into a single Experiential Lovemaking Training Game that can be played on-line and/or distributed via DVD-ROM for Windows and Macintosh platforms. The Game may also be developed for distribution on game platforms such as, but not limited to, Sony PlayStation, Nintendo Game Cube, Microsoft X Box, or the like. Note: The one player Game for Product Family 2 and 3 can use a Biofeedback system as part of the game play interface and can be created to play on Windows and Macintosh platforms only.

### 8. The Experiential Lovemaking Training Product(s) Box Set Kit Without the One-Player Game

This can an be distributed as a box set of DVD/DVD ROMs, audio CDs, with on-line options including MP3 file downloading. Can include all of the above media components except for the game (embodiment 7).

9. The Experiential Lovemaking Training Product(s) Box Set Kit with the One-Player Game

This can be distributed as a box set of DVD/DVD ROMs, audio CDs, with on-line options including MP3 file downloading. Includes all of the above media components including the game.

### 10. One/Two-Player Game

This is the expanded version of the one-player game. It allows both one-player and two-player game play. Two-player game play is enabled between two computers connecting on-line. Each player controls a 3D human model through the process of lovemaking. In the one-player version of the game the player controls the actions of a 3D human model in the process of making love to/with a computer controlled 3D human model. In the two-player version of the game, each player controls a 3D human model as these models interact as lovers making love. The two-player game is similar to a fighting game except that instead of fighting, the characters are making love. This game may be distributed on DVD-ROM for Windows, Macintosh, and LINUX platforms. Two players with DVD-ROMS can interact with each other via the Internet.

The game may also be developed for game platforms such as, but not limited to, Sony PLAYSTATION, Nintendo GAMECUBE, Microsoft XBOX, computers (with operating systems such as, Windows, Macintosh, UNIX, Linux) or the like. In these cases two players interact via game platform controllers. Note that Product Family 2 can use a biofeedback system as part of the game play interface. In addition, note that Product Family 3 does not have a two-player game.

11. The Experiential Lovemaking Training Product(s) Box Set Kit with One/Two-Player Gameplay Options

This can be distributed as a box set of DVD/DVD ROMs, audio CDs, with on-line options including MP3 file downloading and one/two-player game via on-line. Can include all of the above media components: Profiles+Guided Lovemaking+Guided Visualizations+Linear Videos+One and Two player Game play options. Note: Product Family 3 does not have a two-player game.

### 12. Experiential Lovemaking Training Workshops.

In this embodiment the parts and pieces of the box sets of all 3 Product Families may be used together or individually or in any combination by one or more lovemaking trainers in a live lovemaking training environment (workshop).

### Content Database and Content Access

The goals, objectives, skill sets, training modules, and all related training content (interface, transitions, etc) of each product are cross categorically related within a database specific to the product and can be accessed randomly, or sequentially according to the pre-existing “tracks”: Exploratory, Mastery, Refresh. The entire content/training database of all products resides as one, ever-growing database on-line.

Most of the content/training database of a product resides on the DVDs that come with the product. Some of the content/training database of a product resides on the audio CDs or MP3 files that come with the product.

Access to content on-line and on DVDs played on Windows or Macintosh computers, is according to prescribed sequences in response to user input, real time and collected over time. Access to content on a DVD that is played on a DVD video player is menu driven, such as, but not limited to, special features of a movie DVD combined with more real-time menu options typical to current interactive DVD video. For the most part the user will experience pre-scribed sequences when accessing content from a DVD played on a DVD video system.

Access to audio content on audio CDs and MP3 players is menu driven. Linear audio tracks are accessible according to the standard capabilities of a CD player and an MP3 player, such as, but not limited to single track, multiple track sequentially, repeat play of all tracks, and the like.

### Multiple Tracks for Participation

As mentioned earlier in this document, the graphical interface to each Experiential Lovemaking Training Product(s) provides a variety of ways and segments in which an individual can participate with content such as, but not limited to: Product Overview, Create a Personal Profile, Mastery Track, Exploratory Track, Refresh Track, Select a Subject, Select Lovemaking Objective, View Linear Segments, Play the Game, Just Listen, and the like.

Three primary tracks through the Product(s) are:
1. The Mastery Track
2. The Exploratory Track
3. The Refresh Track

The Exploratory Track does not guide the individual towards mastery. However, some individuals will be more empowered by choosing their own path through the content. For those individuals the exploratory track can be more effective than the Mastery Track. This Track lets the individual view and participate in any segment of the program wherever and however desired. It is like the scene selection option of a DVD movie. A user profile will evolve with the individual on this track and the profile will likely make recommendations to that individual. If the individual follows the recommendations, there is a good chance that the individual will inadvertently fall into the Mastery Track. If the individual selects the game play segment of any training session and scores high enough on the game, the individual will be given access to a reward video segment. However, most individuals will need to follow the Mastery Track to score high enough on the game segments to gain access to reward videos.

Lovemaking mastery is best achieved through the Mastery Track. This track guides and tests the individual or couple step-by-step through the training process. This track is gated so that an individual cannot proceed to new training sessions until that individual has mastered previously required training. The Lovemaking Mastery track is like the “play movie” option of a DVD movie menu. It only allows the individual to access training sessions in a specific order and only according to proven success. It moves the participant through the training experience in the order that has the greatest experiential training value.

As an incentive to follow the Lovemaking Mastery Track, some content is only accessible by achieving a high score on the game play segments of each training session. Only a user profile that has a record of game play success will have the ability to re-access this content. There are many more details that could be mentioned here regarding storing and accessing evolving user profiles, but suffice it to say that, for most individuals, access to reward sequences will be something they have to earn and this is best achieved by following the Mastery Track.

The Refresh Track is to be used repeatedly, quickly and simply, to reinforce experiential memory as needed. It provides access only to summarized training and to the game play segments of each training session. So the user of this track can quickly review and then test and practice what he/she should know and be able to do. The Refresh track is not gated, which means that the individual can select refresh training sessions at will in any order. If an individual selects and plays a game segment and achieves a high enough score the individual will be given access to the reward video. If the individual selects Product Overview, it will automatically play the summary segments of the refresh track sequentially through the product from beginning to end. This is a good way for a product user to become familiar with all that the product has to offer without getting bogged down in training details.

### Bridging Steps

Product users can have the option to participate in any step of any training module in any order and users can take this random approach. Therefore, the brief introduction to the profile segment of a training module will play as an audio/visual bridge, whenever a user chooses to go from one training module to another. The introduction to the profile serves as a generic transition between learning modules so that no matter what order people choose to consume the product, whenever they move from one training module to the next a profile intro will always play. This will help to clear the mental/emotional palette of the random user. It will also help to enroll that user in talking time to complete the profile before participating in additional steps. And if the random user chooses not to complete the profile at least the intro to the profile will “clear the stage” for the next lovemaking scene. Therefore, the software will always launch the introduction to the profile between each training module.

### Elements of the Recordings

The Experiential Lovemaking Training Product(s) can combine the emotional power of motion pictures with the personal impact of interactivity to provide truly experiential sex education for individuals and couples. This training can teach healthy, uplifting and sustainable sexual pleasures for both men and women in a manner that is simultaneously engaging, entertaining, elegant, and tastefully erotic. Every training module can use one or more couples to show lovemaking skills in action. The relationship(s) of the couple(s) used to demonstrate lovemaking is revealed through both lovemaking scenes and non-lovemaking scenes. Each lovemaking scene and each real life relationship scene helps to reveal more about who these people are, how they relate and how their lovemaking influences their relationship, health and happiness. When lovemaking scenes and non-lovemaking scenes of the couple (such as in Steps 3 and 5) are played in the order of the master track, they tell the story of a lovemaking relationship. Therefore the entire product tells die story of one or more relationships. We can make every cinematic effort to bring to life the experience of the couples used to demonstrate lovemaking. Our intention can help product users relate to these couples on a more personal and more emotional level as if they were watching a romantic movie with many lovemaking scenes. This makes the lovemaking scenes more emotionally engaging, more erotic and therefore more memorable; and it helps to communicate the purpose and value of the lovemaking training to product users. This also makes lovemaking training more enjoyable, which means that people are more likely to stay engaged in the training long enough to have it make a real difference in their lives.

The aim and result of the training is to enhance a subject's sensual activity, sexual activity, and intimate communication with another partner or the like.

Real Life Actors can portray relationships and lovemaking. Every training module can use one or more couples to show lovemaking skills in action. The relationship(s) of the couple(s) used to demonstrate lovemaking is revealed through both lovemaking scenes and non-lovemaking scenes. Each lovemaking scene and each real life relationship scene helps to reveal more about who these people are, how they relate and how their lovemaking influences their relationship, health and happiness. When lovemaking scenes and non-lovemaking scenes of the couple (such as in Steps 3 and 5) are played in the order of the master track, they tell the story of a lovemaking relationship. Therefore the entire product tells the story of one or more relationships.

Lovemaking demonstrations involving live couples will be carefully scripted so that their actions and dialogue help product users understand what each person in the relationship is doing and experiencing during lovemaking scenes. These scenes need not be pornographic. The Narrator need not be used during these scenes.

The demonstration and explanation segments of each training module do not require live actors to illustrate more explicit information. In these segments real life couples are matched with lifelike three-dimensional (3D) animated models (identical to real life humans). Seamless transitions are made between the real couple(s) and the 3D animated couple making it possible to use the animated couple with graphic enhancements and voiceovers to further demonstrate and explain lovemaking skills. The 3D models can be used to enhance the artistic and erotic presentation of actual lovemaking. With these 3D models it is possible to tastefully exaggerate reality in erotic ways, show sex in ways never before seen, illustrate the flow of energy, and illustrate emotional transformation.

### Three-Dimensional Animated Model Actors are Used for More Explicit Demonstrations and Illustrations of Sex.

These elements of the invention do not need to use these same lovemaking/relationship actors to illustrate more explicit information. Real life couples are matched and with lifelike three-dimensional (3D) animated models (identical to real life humans). Seamless transitions are made between the real couple(s) and the 3D animated couple making it possible to use the animated couple with graphic enhancements and voiceovers to further demonstrate and explain lovemaking skills. The 3D models can be used to enhance the artistic and erotic presentation of actual lovemaking. With these 3D models it is possible to tastefully exaggerate reality in erotic ways, show sex in ways never before seen, illustrate the flow of energy, and illustrate emotional transformation.

### Game Play

The 3D models are also used as virtual lovers in the Simulation/Testing game play segments of each training module. Success at a game segment requires complete understanding and spontaneous memory of what was taught. Therefore each lovemaking game is part of the training process. It can reinforce learning and can help trainees test their knowledge and understanding.

When the segments of the video game are played in the order of the master track the game player will experience each segment as a progressive level of a single lovemaking game. The lovemaking game parallels the story of the lovemaking relationship.

### Experiential Lovemaking Training Product(s) Features and Benefits

Feature: Combines ancient sacred sex training (for example, Taoist, Tantric, Toltec, Quodoushka, and the like) with contemporary psychology and current sex knowledge. Benefit: No other single source effectively combines all this information and training.

Feature: Includes techniques and information that are new to many westerners, for example, male, multiple orgasm (before ejaculation), female ejaculation, cervical orgasm, and absorption. Benefit: Expands the potential enjoyment of sex beyond what the practitioner may have thought possible.

Feature: Employs all primary leaning modalities: visual, auditory, and kinesthetic. Benefit: The combination of these modalities engages both left and right brain resulting in full mind-body participation and integration. This makes the learning/training experience more enjoyable, and much more memorable and therefore effective, thus transforming real life lovemaking spontaneously without effort. No other lovemaking training product can produce this result.

Feature: Experiential Lovemaking Training Product(s) segments offer interactive manipulation of real time rendered objects in pre-rendered environments to provide a game play experience. Benefit: Provides a virtual lover some form of sex simulation, or the like, for participatory training. This significantly improves the individual's ability to apply in real life what is learned during training.

Feature: Incorporates neurolinguistic programming on both DVD and CD. Benefit: Supports subconscious learning and integration of information.

Feature: Uses neuroacoustic audio on both DVD and CD. Benefit: This enables brainwave entrainment, which, in turn, enables mental absorption that enhances sensory enjoyment and facilitates ongoing access to brainwave states that: (a) enhance learning, and (b) enhance intimacy and contribute to a sense of spiritual union.

Feature: Establishes within the adaptive unconscious of the trainee reciprocal stimulus response associations between thoughts, feelings, behaviors and sensory experience, and brainwave patterns, all of which enhance lovemaking. Benefit: This allows the trainee to apply learned lovemaking skills effortlessly during actual lovemaking.

Feature: Combines HDTV resolution video with advanced video and audio effects. Benefit:

Enhances live action video to increase emotional, entertainment and learning value.

Feature: Seamlessly combines live action human performers with matching high-resolution three-dimensional human models. Benefit: Allows tasteful graphic details (without appearing pornographic) and enables simultaneous displays of internal and external anatomy. This also enables illustrations and animations of the energetic, emotional and imaginative inner experience (for example, that which lovers feel, think, and/or visualize).

Feature: Each product can include a personal profile for an individual to better understand his/herself and his/her partner. Benefit: The profile helps the individual to understand more about her/his lovemaking strengths and weaknesses, issues and opportunities. The results of the profile can guide an individual to recommendations and provide a more personalized path through the learning/training experience. The results can also be used to facilitate communication regarding intimate issues between partners. The individual will be given an incentive to upload her/his profile data to an on-line survey database for additional personalized support and other rewards.

Feature: Feng Shui design principals may be applied to the design of every audio visual aspect of the product. Benefit: This is a subliminal way to make the training more effective.

Feature: Color Treatment may be applied to every visual aspect of the product Benefit: This is a subliminal way to make the training more effective.

### The Personal Profile

One step of the Mastery Track is to create a user name and password and then create a personal profile. The personal profile is created by the individual participating in an entertaining, interactive questionnaire process. This profile helps the individual understand her/his lovemaking strengths, weaknesses, preferences, and options. It gives the individual a positive “reality check” on who she or he is in the world of other lovers. The personal profile helps the individual “get real” about lovemaking and at the same time conveys to the individual the “real possibilities” available to those who are willing to give up their addiction to “sexual illusions” and be honest, loving and trained in the art of lovemaking.

As the individual interacts with the invention components, the individual's personal profile evolves. The personal profile enables the software in the product to present lovemaking training content and make recommendations that are specific to the needs and interests of the individual. In essence, the software of the product responds to individual input in real time as well as individual data collected over time to make the entire lovemaking training experience more personal and engaging.

The personal profile keeps track of individual's progress on the mastery track. A user name and password allows the individual to resume interaction with the product where ever she/he left off. To enable this, the user profile maintains a date/time record. When comparing current date and time to most recent user date and time, the software in the product determines if the individual has not participated in the training process for a period of time long enough to have forgotten some essential training. In this case, the program suggests that the individual engage in a specific session or sessions of the Refresh track.

### Upload User Profile

If the individual chooses to upload her/his profile to an on-line database, the individual then accesses additional information, products, and resources that are relevant to her/his strengths, weaknesses, interests and preferences.

### Multiple User Profiles

Each product can store multiple user profiles so that more than one individual can use the product in a personalized way.

### Couples Profile

A couples profile compares and contrasts the individual profiles of two individuals (for example, in a closed system and/or on-line) to reveal their lovemaking compatibilities, differences, strengths and weaknesses. The couples profile provides non-judgmental feedback on the sexual relationship and helps the members of the relationship better understand each other sexually. The couples profile is a communication tool that facilitates the kind of communication about sex that is necessary for a couple to have a truly extraordinary sexual relationship. It facilitates communication for all couples and makes communication possible for those couples that have difficulty talking about sex. As individuals in the relationship make progress through the product their individual and couples profile(s) evolve. In this way the individuals in the relationship continue to get feedback on their relationship. The product then relates the lovemaking training to that specific feedback so that the training process becomes personal to the relationship. In an abstract sense, this allows the individuals in a relationship to experience asynchronous virtual lovemaking that can be very encouraging to a relationship because it provides a non-threatening way for each member of the relationship to demonstrate their commitment to the love life of the relationship. Synchronous virtual lovemaking is also available (see Couples Play, below). The information provided in the couples profile is presented with links to recommended segments within the product that can be used to improve the sexual relationship. For example, the couples profile may reveal differences in arousal rates and differences in preferred arousal techniques. If either member of the relationship wants to better understand how to deal with this issue, that individual can click on the link to the section of the Experiential Lovemaking Training Product(s) invention that deals with arousal and review the segment or learn from it for the first time. This is an important feature of the invention because it presents to the individual what the individual needs to learn in a context of what is demonstrably important to her/his lover.

In a sense the couples profile is a playful communication and personalized training tool that acts like an ever-present sex coach who continues to coach each individual in a sexual relationship to meet each other's needs in a way that is mutually satisfying. For those who haven't been able to communicate about their sexual relationship, using the couples profile component of the product can result in a vast improvement in their love life. When this knowledge of each other's needs is translated into mutually satisfying lovemaking, it can significantly improve a sexual relationship. All of the embodiments of the invention can consistently reinforce a way for individuals to be together that helps them to meet each other's needs in a self-satisfying way.

The ability to experience pleasure through providing pleasure to a lover is a skill that is fundamental to lovemaking training for sustainable sexual satisfaction. Therefore the software component in the Experiential Lovemaking Training Product(s) is designed to help individuals develop this skill. Every training session involves feedback from a virtual lover. When there is a couples profile established, the virtual lover can then take on the attributes of a real life lover. For example: A virtual lover may enjoy all forms of genital foreplay, whereas a real lover may be very particular about certain types of genital foreplay. While the experiential training of the invention attempts to broaden lovemaking awareness and repertoire, it never imposes lovemaking alternatives upon real individual preferences (assuming those preferences are not impedimentary to sustainable sexual satisfaction). Healthy preferences become part of the lovemaking training experience through the profile software and this is especially valuable when there is a couples profile for the software to use. This is one of the fundamental and unique value propositions offered by the experiential training.

As couples upload their profiles into an on-line database they gain access to recommended products, additional information resources, and other potential services (such as sex and relationship counselors in their area). This on-line feature is very empowering to long-distance relationships. Two individuals can upload their profiles to the on-line database and they can then mutually select to have the on-line system generate their couples profile. As the members of a long distance relationship continue to update their individual profiles they can continue to update their couples profile. Details regarding synchronous and asynchronous couples play on-line are also included.

Two individuals that are in a sexual relationship or considering a sexual relationship can use the evolving couples profile on-line to communicate about their sexual relationship or explore a potential sexual relationship. This has very exciting peer-to-peer marketing implications and the potential to become a significant product for people engaged in on-line matchmaking activities.

Different versions of the invention method and kit can be created for individuals having differentiated learning and receptivity capabilities. For example, individuals can be tested for openness to absorbing and self-altering experiences prior to using the method and/or kit. Testing can use, for example, but is not limited to, a Tellegen Absorption Scale (TAS), that can evaluate whether an individual is particularly receptive to a form of experiential training as disclosed herein. The components of the kit or the method can be adapted for use by the individual based upon a previously-determined relationship between effectiveness of an experiential method or kit and the TAS score evaluated from individuals with different capabilities. Such methods for testing are well known in the art.

### Multiple Tracks for Participation

As mentioned earlier in this document, individuals have three tracks by which they can participate in the lovemaking training of the invention: i) The Exploratory Track (allows the individual to participate in any order, at will) ii) The Lovemaking Mastery Track (designed to guide the individual or couple to success) iii) The Refresh Track (designed to help the individual refresh his/her lovemaking mind and experiential memory and practice lovemaking skills).

The Exploratory Track does not guide the individual towards mastery. However, some individuals will be more empowered by choosing their own path through the content. For those individuals the exploratory track can be more effective than the Mastery Track. This Track lets the individual view and participate in any segment of the program wherever and however desired. It is like the scene selection option of a DVD movie. A user profile will evolve with the individual on this track and the profile will likely make recommendations to that individual. If the individual follows the recommendations, there is a good chance that the individual will inadvertently fall into the Mastery Track. If the individual selects the game play segment of any training session and scores high enough on the game, the individual will be given access to a reward video segment. However, most individuals will need to follow the Mastery Track to score high enough on the game segments to gain access to reward videos.

Lovemaking mastery is best achieved through the Mastery Track. This track guides and tests the individual or couple step-by-step through the training process. This track is gated so that an individual cannot proceed to new training sessions until that individual has mastered previously required training. The Lovemaking Mastery track is like the “play movie” option of a DVD movie menu. It only allows the individual to access training sessions in a specific order and only according to proven success. It moves the participant through the training experience in the order that has the greatest experiential training value.

As an incentive to follow the Lovemaking Mastery Track, some content can be only accessible by achieving a high score on the game play segments of each training session. For example, only a user profile that has a record of game play success will have the ability to re-access this content. There are many more details that could be mentioned here regarding storing and accessing evolving user profiles, but suffice it to say that, for most individuals, access to reward sequences will be something they have to earn and this is best achieved by following the Mastery Track.

The Refresh Track is to be used repeatedly, quickly and simply, to reinforce experiential memory as needed. It provides access only to summarized training and to the game play segments of each training session. So the user of this track can quickly review and then test and practice what he/she should know and be able to do. The Refresh track is not gated, which means that the individual can select refresh training sessions at will in any order. If an individual selects and plays a game segment and achieves a high enough score the individual can be given access to the reward video. If the individual selects Product Overview, it can automatically play the summary segments of the refresh track sequentially through the product from beginning to end. This is a good way for a product user to become familiar with all that the product has to offer without getting bogged down in training details.

### Game Play for Simulation and Testing

The invention includes a combination of Linear Media, interactive media, Game Play, neuroacoustic technology and neurolinguistic programming specifically designed and integrated as a method for truly effective lovemaking training. This methodology makes the lovemaking training experiential. The reason for making lovemaking training experiential is to provide the participant with a truly effective and somewhat effortless way to take into experiential memory (mental, emotional, energetic, and physical memory), specific lovemaking knowledge and skills that can then be applied effortlessly in actual lovemaking. The most experiential training possible is hands-on in real life. As explained above, this is no an affordable, practical or comfortable way for most people to master lovemaking. The next best way to m; training experiential is to provide hands-on simulation through interactive media. The best simulation in media is found in games that can be played on computers and/or on proprietary game play platforms such as Sony PLAYSTATION, Microsoft X-BOX, and Nintendo GAMECUBE, and the like. The 4^{th} step in an 8 step training module of a Experiential Lovemaking Training Product(s) is to engage the user in an interactive experience that simulates the lovemaking skill taught in the training module.

Interactive game-play can be used to provide both simulation and testing. This simulation both tests and reinforces what was taught.

The 3D models used in the explanation segments of the training modules can also be used as virtual lovers in interactive game-play segments of each training module. Game play includes, but is not limited to, interacting with these 3D virtual lovers in a way that simulates intimacy building and/or sexual lovemaking.

The game play segments of the product are playful tests of what the product user should know and be able to do as a result of participating in the training session. These game play segments also play a very significant role in reinforcing what is to be known and learned. The game play can engage both right and left brain participation and involves the individual in a personalized kinesthetic process, all of which can significantly impact experiential memory.

The emotional quality of each game play segment depends on the nature of the game-play and the training to be tested by that game play. Some game play sessions have humorous quality while others are more like a romantic journey.

When the segments of the video game are played in the order of the master track the game player will experience each segment as a progressive level of a single lovemaking game. The lovemaking game parallels the story of the lovemaking relationship.

The Experiential Lovemaking Training Product(s) uses interactive media and game play on Windows, Macintosh, and LINUX operating systems to make lovemaking training more personal and engaging. Each training session includes a segment that allows the participant to demonstrate knowledge and skill through success at game-play. Game play includes, but is not limited to, interacting with graphic three-dimensional game characters (that look human) in a way that simulates lovemaking.

The game play segments of the product are playful tests of what the product user should know and be able to do as a result of participating in the training session. These game play segments also play a very significant role in reinforcing what is to be known and learned. The game play can engage both right and left brain participation and involves the individual in a personalized kinesthetic process, all of which can significantly impact experiential memory.

### Training Categories, Segments, Objectives, and Measures of Success

The Experiential Lovemaking Training Product(s) is divided into categories of Lovemaking Mastery. Each category includes an overview segment, an information and demonstration segment, and a training segment. Each training segment includes specific objectives to be accomplished. Each bit of knowledge and each single skill to be learned in a training segment has a learning objective. A learning objective defines exactly what the learner will know and/or be able to do as a result of successful learning. Learning objectives include measures of success; which are ways of proving to the learner that they have accomplished the learning objectives.

The game play sections within each training segment provide a playful and personally impressionable way for the individual to measure her/his learning success. The accomplishment of training objectives is demonstrated by the individuals' ability to do something in the lovemaking game. The user of an Experiential Lovemaking Training Product(s) is encouraged to demonstrate knowledge and skill much as a video game player must know something, have something, or have an acquired skill, to proceed to a new level of a video game.

### Synchronous and Asynchronous Couples Experiential Lovemaking Training Game Play

The invention can include synchronous and asynchronous couples Experiential Lovemaking Training game-play for closed systems and for systems connected on-line and for game platforms. Versions of this game can include on-line voice to voice (voiceover iP). This is similar to an on-line fighting game except that the interaction is lovemaking. The on-line version of the game makes a very nice compliment to the couples' profile. The couples profile and two-player game are powerful tools for on-line matchmaking and virtual dating.

The game can be ported to other game platforms as well; such as Sony PLAYSTATION, Nintendo GAMECUBE, and Microsoft X-BOX, and the like. (See Example Training Module, below)

### Multimedia

The “Mind-Body Learning System and Methods of Use” as applied to Lovemaking Training can includes the following:

1) An overview or Summary Segment (audio/video, graphics)

2) Complete Linear Demonstrations (audio/video, graphics) (includes neurolinguistic programming (NLP) script and brainwave entrainment audio to facilitate learning and memory)

3) Game-Play (audio/video, graphics) (includes NLP script and brainwave entrainment audio and music to facilitate states of mind most conducive to lovemaking mastery).

4) Rewards (audio/video/graphics) (includes brainwave entrainment music to elicit states of mind most conducive to lovemaking mastery).

5) Printable text with affirmations, mantras, possible lyrics, reminders, and other keyword cues.

6) Reinforcement and Entrainment (Separate audio CDs for brainwave entrainment to elicit states of mind conducive to lovemaking mastery and some NLP to reinforce positive thoughts for sustainable sexual satisfaction).

The duration of each segment of training within each category of lovemaking mastery depends on the specific information and skills to be learned. Game-play sequences are also variable in length depending on the skill of the play and the skill to be mastered.

### Neurolinguistic Programming

Each training segment includes written, spoken, and recorded content based on principles of neurolinguistic programming (NLP). Key words will be used inside of positive affirmations which when repeated over and over again become a part of the subconscious memory of the individual.

### Neuroacoustic Audio Training

The “Mind-Body Learning System and Methods of Use” uses neuroacoustic sound generation and processing in specific segments of the DVDs and also on separate audio CDs (or audio tapes, CD-ROMs, or the like). In part, this sound generation and processing is designed to elicit specific brainwave frequencies to empower Lovemaking Mastery. This process is termed Brainwave Entrainment. As described above, the human brain is always generating a combination of brainwave frequencies (beta, alpha, theta, and delta). Every state of mind and every emotion appears to have a corresponding set of brainwave frequencies or frequency pattern consisting of a combination of types of brainwaves but usually involving one type of brainwave that is more dominant than the others. The relationship between various states of mind and their corresponding brainwave frequency patterns is fairly well known and widely published by some neurological researchers. For example, through EEG brain mapping, heart rate variability, galvanic skin response, rate of breathing, and other stress monitoring, some researchers in the field have established the frequency patterns associated with deep stress-reduction, emotional release, advanced healing, mega learning, peak performance, ecstatic states of consciousness, expanded meditation, and personal transformation, etc.

In parallel and related studies, some researchers have determined how to use sound to entrain the brain to specific frequency patterns. This is known as Brainwave Entrainment. In this way sound can be used to elicit specific states of mind. For example, sound may be used to elicit a state of deep rest and relaxation.

The instant invention uses sounds that elicit states of mind and emotions that are conducive to learning and that are conducive to lovemaking mastery. In some segments, sound will be used to elicit states of mind conducive to active learning. In other segments sound will be used to elicit states of mind conducive to deeply satisfying lovemaking. The sounds conducive to lovemaking will comprise music and this will be featured on audio recordings, such as, but not limited to audio CDs, audio tapes, or CD-ROMs, or the like, that come with each kit and method.

Some poetic neurolinguistic messages can also be mixed in with the music to reinforce the individual's thoughts that are conducive to love and lovemaking mastery. While these sounds and words are heard during segments of the training process, they are also available in extended versions on the audio CDs, audio tapes, or CD-ROMs, or the like, that come with each kit and method. These audio recordings are played as often as the individual likes and especially during actual lovemaking.

When brainwave entrainment is accompanied by neurolinguistic messages and color-coded visual imagery the messages and the imagery become a part of the subconscious memory and become associated with the brainwave states in which they were heard. This combination is part of the method of the invention to make experiential training a part of experiential memory. Through continued use of method and kit the individual will not only experience states of mind that empower sustainable sexual satisfaction and can lead to sexual spiritual fulfillment, but also be able to spontaneously access those states of mind during actual lovemaking.

The experiential training methods and kits of the invention provides the repeat experience of associations between thoughts, feelings, behaviors, sensory experience, and brainwave patterns that enhance sex with images, sounds, words, demonstrated behavior, and user-caused behavior (including, but not limited to, interactive media and game play). Over time these conditioned response associations can become part of the individual's adaptive unconscious and have a positive influence on real lovemaking. During actual lovemaking the thoughts, feelings, behaviors, sensory experience, and brainwave patterns that are associated with various aspects of sex in the adaptive unconscious (as the result of Experiential Lovemaking Training) then become associated with the sights, sounds, smells, tastes, touch sensations, movement, and all related sexual behaviors of actual lovemaking. When this happens sex positive associations in the adaptive unconscious and actual sex are mutually reinforcing, making it increasingly possible for the trained person to have a satisfying sexual experience. The invention establishes reciprocal stimulus response associations in the adaptive unconscious of the individual.

It has been said that the brain is the most important sex organ. The experiential training methods and kits of the invention not only give the individual's mind useful and erotic lovemaking information but they also train the individual's brain to transition into and to retain brainwave frequency patterns that make the application of that knowledge easy and deeply satisfying. No other product exists that provides personalize experiential training accompanied by brainwave entrainment, neurolinguistic programming and color-coded imagery for sustainable sexual satisfaction and sexual spiritual fulfillment.

The invention will be more readily understood by reference to the following examples, which are included merely for purposes of illustration of certain applications, aspects, and embodiments of the present invention and not as limitations.

### EXAMPLES

### Example 1

### Eroticize the Body

### Step 1 The Personal Profile/Couples Profile (Computer Only)

### Brief Description

The profile questionnaire begins at the start of each product and continues, incrementally, at the beginning of each training module. Similarly, the questionnaire is available on-line for complete and incremental access.

### Example

The program plays a very short (approximately 10 second) entertaining linear video (live action or animation or some creative combination of the two) to enroll the individual in completing the brief questionnaire that is at the beginning of the training module. This questionnaire is designed to stimulate a more personal involvement with the subject matter of the training module. The answers to the questionnaire contribute to the individual's personal profile. The answers also contribute to the couples profile for those couples that have elected to create one. The questionnaire asks questions such as:

1. Rate the sexual sensitivity of the following parts of your body.

2. Rate the sexual sensitivity of the following parts of your lover's body.

3. Have any areas of your body increased or decreased in sexual sensitivity? (What areas? Select from the following).

4. Have any areas of your lover's body increased or decreased in sexual sensitivity? (What areas? Select from the following).

5. What areas of your body would you most like to become more sexually sensitive? (Assign a 0 to 5 rating of desire for each of the following body areas).

6. What areas of your lover's body you would most like to become more sexually sensitive? (Assign a 0 to 5 rating of desire for each of the following body areas).

7. When in a public place what parts of your body are you comfortable having your lover touch? (Select from the following).

8. If your lover were to touch any one of these parts of your body in public, which one would likely to generate the most erotic desire? (Select from the following).

Questions may be phrased differently than in the above examples.

Playful styles for the questionnaire includes such treatments as:

1. Vocal erotic sound effects responding to each completed answer until all completed answers culminate in the sound of some one having an orgasm. In this case, heterosexual male users will hear female vocal effects and heterosexual female users will hear male vocal effects.

2. A playful spoken response that is more specific to each question answered. 3. An audio parody of a TV game show or TV dating show, possibly with a summary statement (such as, for example, the computer game titled “You Don't Know Jack”).

At the end of the questionnaire the individual has feedback that consists of a summary statement of the individual's preferences and current strengths and/or weaknesses relative to accomplishing the lovemaking objective. If the individual and his/her lover are creating a couples profile they both have the opportunity to see each other's specific answers and summary statement; and they both receive recommendations and general statements regarding the individual's knowledge (or lack of knowledge) of one another and recommendations to help then accomplish the lovemaking objective in their real life relationship.

### Step 2: Summary (Computer and DVD).

### Brief Description

The summary provides a quick overview of the interrelated lovemaking goals, objectives, and skill sets that are addressed in the training module. It shows and tells what will be taught by the training module and why. The summary is also designed to excite users to proceed with the rest of the training module.

The summary uses a Narrator and a linear montage of shots and scenes from step 3 (demonstration/explanation) and from step 5 (reward video). It also includes brief comments from the lovemaking actors (either in or out of character).

After viewing the summary the individual understands the purpose and value of the training they art about to receive and they will have heard and seen, in a rapid and exciting form, everything they will learn in the training module.

### Audio

All demonstrations and explanations include brainwave entrainment audio/music to enhance learning ability.

### Color

Color Treatment is used to enhance learning.

### Example

In this example a montage of close-ups are used to: (a) Show people reacting with sexual sensitivity to being touched in non-erogenous parts of their bodies (b) Show how these non-erogenous body parts became so sexually sensitive.

The close-ups used in this summary are of various couples, videotaped from various angles and in various settings. While viewing this montage of “touching scenes” the Narrator describes how the individual can make the individual's entire body an erogenous zone through a process of association by touching non-erogenous parts of the individual's lovers body, while the individual's lover is in a state of high sexual arousal. Quick shots illustrate the Narrator's comments. Additional animations, showing the sexual energy flow from an erogenous zone to a spot being touched, are inter-cut with live action shots to further the illustration. The Narrator goes on to say that while these associations are typically established during lovemaking, once established, they become very enjoyable in everyday situations and can be used for prolonged foreplay.

### Step 3: Demonstration and Explanation (Computer and DVD)

### Brief Description

The demonstration/explanation segment of each training module contains all that a product user needs to know and be able to do to accomplish a lovemaking objective as specified by the training module. Therefore these segments are considerably longer than the summary segments. Sometimes the demonstration and explanation are all together. Sometimes the explanation is separate from the demonstration and is interactive. Linear segments can be displayed on both computer and DVD video. Interactive segments display on computer only; although, depending on design, there may be some minimal interactivity enabled by the remote control of a DVD video player.

Each Demonstration/Explanation segment begins with a live individual and/or couple engaged in a sexual or intimacy-building activity. They will be doing whatever the training module is teaching, as stated in the summary of the module. What they do and say will demonstrate the skill that will then be further explained.

At some point during the demonstration, the live individual and/or couple transitions to a matching 3D animations, and that is where the narrator begins the explanation. The explanation includes, where applicable, graphic illustrations with views both outside and inside the body. Generally, at the end of the explanation, the 3D animations transition back to the live people and the scene ends with the live people either still in the process of demonstrating the skill being taught or in the process of transitioning their session, sometimes to another sexual or intimacy-building activity, sometimes to the end of their activity.

### Audio

All demonstrations and explanations include brainwave entrainment audio/music to enhance learning ability. Neurolinguistic programming may be used for some portions of the Narrator's script.

### Color

Color Treatment may be used to enhance learning.

### Example

In this example we demonstrate how to eroticize the individual's lover's body. To demonstrate this we show a man eroticizing the neck of his lover. This is one of several treatment options.

This example begins with music, lovemaking sounds (breath, bodies moving together, voices that are whispered yet audible). Heart beat sounds are used subliminally and/or non-subliminally to enhance entrainment. If possible, the rhythm of the music matches the rhythm of the couple making love. It is clear by what we hear and see, that these lovers are in a multi-orgasmic state, hovering on the verge of coming again. Their impassioned whispers also inform us that the man is deliberately eroticizing the woman's neck and she is completely surrendered to the pleasure of this process.

We see the man delicately stroke the neck of the woman in a feather like way with the back of his slightly curved fingers. The flat surface of his fingernails barely touch her neck as he strokes from behind her earlobe down the front of her neck to just above the cleavage of her breasts, and then back again to her ear lobe. He continues stroking in this way slowly, down then up her neck. His fingers glide gracefully in sync with the motion of his hips as they make love. As he thrusts slowly and deeply into her, his fingers glide down the full length of her neck. And as he slowly pulls back from the depth of her receptive love his fingers move back up the length of her neck. This process becomes visually apparent; down the neck as he moves in, up the neck as he moves out, in and down, out and up, slowly in perfect synchronization. We can tell by the woman's breath and sighs, and by her goose bumps and trembling body that the delicate sensations she feels in her neck are effecting her entire body; and that her entire body is in an orgasmic state. The man continues in this way as the woman flutters through another orgasm.

As the woman orgasms the bodies of the couple transition gracefully into 3D animated models that are essentially identical to the live couple. The 3D animated models are positioned and moving in a way that is also identical to the live couple. Before we can visibly recognize the difference between the live couple and the 3D models, the surface of the models begin to transition to take on the look of colored glass, transparent yet reflecting light while also filled with color. The 3D models are like perfect, life size animated glass sculptures of a man and a woman, anatomically correct and completely naked. At times more anatomical detail is added to these graphically generated bodies. The detail can be inside or outside the body or in both locations. This computer-generated imagery makes it possible to graphically illustrate what the couple is doing from various views, both inside and outside of their bodies, animated and still. It makes it possible to travel around and through each body while also animating energy flows.

In this example we use these effects to graphically illustrate the connection between the motion and pleasure of intercourse and the motions of touching and the sexual sensitivity of the neck. We can see the man's penis moving inside the woman. We see the tip of his penis touch her cervix just as his fingers reach her cleavage. And we then see how the mans penis pulls back to the very opening of the woman's vagina as his fingers reach the spot just behind her ear lobe. And because this is shown using 3D animation we can use fluid colored animation to enhance the illustration of what is happening within the couple energetically and emotionally.

As the skill is described, explained and shown, the live couple may occasionally be used to “punctuate” some part of the explanation. But the live couple is always presented more like a movie than an instructional or pornographic video. So whenever the live couple is shown the narrator does not speak. Our view of the live couple is never compromised emotionally. Transitions to and from the actual couple will be orchestrated in sound and picture so as not to collapse the emotional experience of lovemaking with left-brain explanations of lovemaking skills.

At the end of the lovemaking skill explanation the 3D animated couple transition back to the live couple. In this example the live couple is still making love. The scene clearly establishes their location and time of day to help make sense of relationship scenes that will appear later in the module (during Step 5, the reinforcement/reward video). For example: As we see the couple making love fairy like shapes of spring morning light dance on their bare skin. The sound of the lovers and music drifts and fades slowly as the camera pushes into them, then past them to travel out a nearby window and reveal the morning sunlight shinning through the puffy white spring blossoms of a large cherry tree. End of scene.

### Step 4: Simulation and Testing (Game-Play) (Computer)

### Brief Description

This step is used to test the individual's knowledge and understanding of what was just taught in the training module. It also helps reinforce the teaching. The game play uses interaction with an attractive 3D animated model (choice of male or female) as the graphical interface for “winning” the game. This simulates the physical training that must become part of the individual's experiential memory for lovemaking mastery. The game is playful, amusing and for some it will also be erotic.

### Game Play Engine

A single role-playing game engine that combines two types of role playing, first person physical and 3^{rd} person strategic is created. Both are interconnected to make one game. The 1^{st} person physical game play represents the physical aspects of lovemaking. The 3^{rd} person strategic role-playing game represents the emotional and energetic aspects of lovemaking. In the 1^{st} person physical game play, players control the lovemaking of a 3D sex model (represents the game player) that is having sex with another 3D sex model (represents the lover of the game player). The way they relate physically drives the behavior of tiny sex characters in the 3^{rd} person strategic game.

Initially the game play only allows for heterosexual lovemaking training. Eventually same sex relations will be possible. The player of the game must choose a gender and a character to control. Whatever gender the player chooses will determine the gender of her/his lover. In Experiential Lovemaking Training Product 1, males get female lovers and females get male lovers.

There are also two sets of tiny male and female characters. If a game player is controlling a female character, she/he initially influences the behavior of the little female characters in the game. If the player is controlling a male character he/she will initially influence the behavior of the little male characters in the game.

The basic behavior of the other, tiny characters is to walk around ignoring and avoiding one another. Occasionally they bump into each other and this will result in either an insult or some flirtatious behavior, depending on the performance of the game player at the time of the collision. As the game player succeeds at increasing the pleasure of her/his 3D lover that pleasure will cause the tiny characters to become more flirtatious, then more interactive until eventually these tiny characters will also begin to make love.

The more tiny couples having sex the better. However, depending on the skill of the game player, these tiny characters can also stop having sex and move away from each other. They may even resort to insults. They are easily distracted by other tiny characters. They are lazy and easily bored. So getting all the tiny characters to continue to make love requires lovemaking knowledge and skill.

### Goals and Challenges

Emotions are rated from “bored” to “exalted love”. Physical feelings are rated from “dead meat” to “multi-orgasmic”. The goal is to achieve a state of exalted, multi-orgasmic love for both the character controlled by the game player and, if present, the character which is a graphic 3D lover. The game player must cause his/her character to interact with the virtual lover in a way that produces that results in both characters expressing the behaviors of an exalted, multi-orgasmic state. The game player must be able to sustain this exalted behavior long enough for all the tiny game characters to reach the same exalted multi-orgasmic state. When all the characters in the game have reached the point of unstoppable exalted multi-orgasmic love they all have one big simul-orgasm, little cartoon hearts float up in the screen, and many little voices (male and female) can be heard saying “I love you”. All of this signifies that the player is a “winner” of the game and is ready for the next learning module.

The game player must master the required (sexual or intimacy-building) lovemaking skills of a game segment and simulate that mastery to win the game segment. Game play that is less than masterful is revealed by the behavior of the graphic surrogate lover and by the behavior of the tiny characters.

It takes masterful game play to get all of the characters to make love and continue to make love long enough to “win” the game play segment. To do this the game player must be skilled at controlling his/her graphic 3D sex character to interact with the graphic 3D lover, in such a way as to do all the “right things” in all the “right ways” at all the “right moments” and for as long as is considered “necessary”, as defined by software settings within the game play engine.

### Views

Game players can switch between 1^{st} or 3^{rd} person views. From each view there are multiple angles from which to choose and players can change views and angels at any time. For success within a game segment the player will need to choose the optimum view and angle for optimum performance.

The 3^{rd} person strategic game view is always isometric. Players can zoom in and out of this view and are given some ability to track left/right/up/or down to get a closer view of the tiny characters. Both physical and strategic game views are always displayed simultaneously. Players can control the screen size of each game view to make one or the other aspect of game play more dominant. We predict that players will initially prefer the first person view because it will give them a better look at how they are controlling their character and how it is affecting the surrogate lover. But as players become skilled at controlling their character, they will probably prefer the third person view to see how their game play is affecting the behavior of the tiny characters. When a game player can sustain and third person, strategic game view, and still cause the tiny characters to make love consistently that game player is considered to be in the “lovemaking gameplay zone”. This is akin to real life lovemaking when the individual can use physical lovemaking skills will keeping his/her attention on what his/her lover is experiencing.

### Control Parameters

To make a game that helps teach lovemaking it is necessary to quantify the various aspects of lovemaking. Which may seem counter intuitive to sex but is necessary for software.

For the sake of this game, lovemaking consists of physical behavior (1^{st} person physical game play and emotional/energetic reactions (3^{rd} person strategic role playing). Physical behavior is represented by a first person interaction between the game player as a 3D human character and the individual's lover as a 3D human character (or virtual surrogate lover). Multiple tiny 3D human male and female characters represent the emotional/energetic responses of the virtual surrogate lover) Control parameters include the quantification of such things as:

Physical Parameters (possibly including):

Select body

Select partner

Select function(s) (touching, kissing, oral sex, intercourse, combinations, etc.)

Select position

Select body part(s) (head, torso, arms, legs, feet, hands, fingers, lips, tongue, genitals, diaphragm for breath, chest for breath, nose for breath, mouth for breath, etc.)

Control selected body part(s) in real time according to
type of motion
rate of motion,
repetition of motion
pressure of motion
height, depth, breadth of motion
   Note: once a body part is set in motion it will stay in motion until put to rest or set in another motion. Game play testing will determine whether or not it is important to allow the game player to save a body part motion for future use.

Emotional/energetic parameters are defined by the artificial intelligence (A-I) of the tiny characters in the strategic role playing game. These characters behave according to their A-I that is heavily affected by the physical behaviors of the larger characters, which in turn is determined by the game players interactions. In other words, as a game player interacts according to the above parameters and causes his 3D sex partner to reach various levels of arousal and pleasure (as defined by the tuning of the game play engine), software measures of success for those parameters will affect the following A-I parameters that control the behavior of the tiny sex models in the strategic role playing game:

A-I Parameters:
Sexual desire
Sexual energy
Physical likes
Physical dislikes
Laziness
Tendency to be distracted
Ecstasy
Happiness
Boredom
Irritation

Calculations between the physical and emotional/energetic parameters (A-I) drive the behavior (animations and sounds) of the tiny sex models.

A-I Behaviors include such things as:
Pushing away
Walking away
Laying down to sleep
Sleeping
Getting up
Walking towards a character (proximity and sex based)
Flirting
Touching
Hugging
Kissing
Oral sex
Intercourse
Orgasm
Repeat orgasms
And possibly something that represents an out-of body experience.
Other behaviors can be scripted.

For each A-I parameter there are thresholds relative to launching tiny character behavior. Behavior sequencing and thresholds are set differently for each tiny character so that they do not all do the same thing at the same time in response to user performance.

In other versions of this game, tiny characters are given memory so that they are taught by the game player. In that case the learned behavior is carried on from one game segment to the next.

### Mechanical Interface

As much as possible the computer mouse will be used to control the behavior of game characters in real time. The mouse can be used to position the 3D model body and move body parts. The intention is for a player to move her/his mouse over the a body part, move the mouse to start moving the body part, and when the motion is correct, click the mouse to capture and sustain the motion. Keyboard keys and key sequences will also be used. For example: Pressure can be selected by a key on the numeric keypad: 1=soft, 2=medium, 3=heavy, etc. Specific mouse moves and specific key combinations will be defined by more detailed game design.

### Gender Exploration, One and Two-Player Versions

In all of the game segments of the first product the player chooses a gender and then interacts with the opposite gender. Typically male players choose male characters and female players choose female characters but these choices are not required for success or learning. In fact, role-playing with the opposite gender can be very beneficial to lovemaking training. Role-playing as a female is not the same experience as role-playing as a male. Players will be encouraged to experience both genders. This is beneficial to Experiential Lovemaking Training and provides twice the amount of game play. For some it will be twice as much fun. Gender reversal also gives couples more experience to discuss and we may choose to facilitate this discussion in the couple's profile.

In future two player versions of this game it will be very beneficial to a heterosexual lovemaking relationship for the male to role-play as the female and a female to role-play as a male. This is a safe, playful, and sometimes funny way for each member of the relationship to understand the other and this can also stimulate useful communication about their lovemaking behaviors, styles and preferences. But, again, we will start with a one-player version for single computer systems only.

### Game Platforms

Initially this is a single player game. Later versions will be two-player on-line; meaning two players can connect on-line, each select a 3D human sex model to control, and control their interaction together in real time. Their “collective” real time interactions will result in controlling their tiny sex model characters. Ideal versions of this game would include on-line voice to voice (voice-over iP). This is similar to an on-line fighting game except that the interaction is lovemaking. The on-line version of the game makes a very nice compliment to the couples' profile, both of which serve on-line matchmaking.

If the two-player game is successful on Windows and Macintosh platforms via on-line interaction between two computers, then the game may be ported to other game platforms as well; such as Sony PLAYSTATION, Nintendo GAMECUBE, and Microsoft X-BOX, and the like.

### Audio

Game play segments include brainwave entrainment audio/music to enhance lovemaking. Therefore a significant portion of the sound track of each game segment is continuous during game play. In addition, game soundtracks include various vocal and other sound effects, and key words and phrases in response to user input. These effects, words and phrases are used for reinforcement and repeated throughout the game as a neurolinguistic response to user behavior.

### Color

Whenever possible Color Treatment will be used to enhance the emotional and energetic experience during of game play.

### Step 5: Reinforcement/Reward Video.

### Brief Description

This engages the trainee's emotions in a memorable scene that reinforces what was taught and further illustrates how the lovemaking skill, when applied in real life, can influence the quality of a relationship.

Reward videos may vary in style from romantic vignettes to highly charged erotic videos. In every case, they are fun to watch, emotionally charged and very memorable.

### Audio

Reward videos include brainwave entrainment audio effects and music to compliment and enhance lovemaking.

### Color

Color Treatment may also used to give the scene emotional impact and make it more memorable.

### Example

The following example is a reward video that is in the style of a romantic vignette. The story of the couple (seen in Step 3) continues. As established at the end of step 3, it is now a warm spring afternoon. The lovers are strolling through a colorful outdoor farmers market. They are casually dressed. The man is carrying a hemp bag of fresh vegetables in one hand and has his other arm around the woman as they stroll. The ambience of the market is delightfully laced with sounds of street musicians playing in the distance, children playing, and people talking as they shop.

The couple drift effortlessly into and out of embrace as they move from one vegetable stand to the next. They appear relaxed and very happy together. The woman stops to sample some fresh organic strawberries (hothouse grown). Delighted by the flavor, she turns to share her pleasure with her lover by placing one small and perfectly ripe strawberry in his mouth. He smiles and looks into her eyes. Words are not needed. As she turns back to select a basket of these strawberries the man begins to caress the woman's neck, gently, with the backs of his fingers, in the same way that was illustrated in Step 3. He is standing behind her with his arm slightly reaching around her shoulder to stroke her neck in the same place and in the same way that we saw him touching her during lovemaking. Her attention visibly shifts from the basket of strawberries to what she is feeling, and her eyes close slightly for a couple of seconds. The ambience of the market fades into the distance and we faintly hear the sounds of their lovemaking as it was during their lovemaking scene (Step 3). No one else in the market appears to notice them. They are “alone” in their connection for these few precious seconds. As her eyes open she turns slightly and discreetly towards the ma and looks deep into his eyes to communicate that she knows what he is doing and how good it feels to her. And then she shudders slightly and makes a playful fall into his chest as if to say “take me I'm yours”. They both know what each other are feeling and for just a beat, they return to the pleasure they shared in bed. The scene then cuts to a reverse angle, which is a full body shot of the couple together in the market. She immediately turns back to face the strawberries and with a smile still lingering, she playfully collects herself as the ambience of the market returns. As she resumes shopping, pretending that she and her lover did not just experience time “standing still”, the man is charmed by her grace and playful gestures and by the fact that she wants him as much as he wants her. Other shoppers pass through the frame. Quick fade to black.

### Using the CD Audio or MP3 Files

### Step 6: Guided Visualizations (Audio Player Only).

The guided visualizations engage the imagination of the trainee in a process designed to increase “absorption” and “senusalization” skills. These audio only stories are accompanied by brainwave entrainment music/audio. The brainwave entrainment evokes states of mind that are conducive to intimate lovemaking. The Narrator will also use neurolinguistic programming to reinforce positive lovemaking messages.

These audio segments can be used comfortably and easily in any location. They are best heard through quality headphones but they also work well for couples using a speaker system.

The process of these audio sessions is to use music and audio effects (subliminal and/or non-subliminal) to entrain brainwave patterns that enhance lovemaking; and to associate these brainwave patterns with lovemaking words, thoughts, stories and visualizations that bring to mind lovemaking behaviors. In addition, key words are strategically placed for neurolinguistic reinforcement of loving, healthy and spiritually supportive lovemaking.

Through repeat use of these audio segments, the user will, in time, become consciously familiar with the brainwave patterns that enhance lovemaking and be able to generate them at will. By associating these brainwave patterns with lovemaking words, thoughts, feelings and behaviors, the repeat user of these audio segments will subconsciously shift into brainwave patterns that enhance lovemaking whenever these lovemaking words, thoughts, feelings and behaviors are present.

### Example

A Narrator tells an erotic story that provides a guided visualization through a complete lovemaking experience. These stories begin with relaxation techniques and then take the individual on a lovemaking journey from pre-foreplay through foreplay, and from there all the way through multi-orgasmic states to an out of body sexual spiritual experience. Then the story guides the individual back into the individual's body and from there through various states of disengaging from the individual's lover in ways that keep the individual deeply connected. These stories help engender self-love as well as love for the individual's partner.

The stories are usually about lovemaking in natural, comfortable settings and include many references to all the senses. Simply through hearing the story, music and sound effects the listener imagines all the other sensory experience (see, feel, smell, taste).

And while listening and imagining the user also experiences the brainwave entrainment and neurolinguistic process.

The Narrator speaks directly to the individual and guides the individual to visualize the individual's location, him/herself and the individual's lover. The narrator is recorded very intimately, as if her/his mouth is right near each of the individual's ears. Music and sound effects, including subliminal audio, is carefully mixed to transform the listener.

### Step 7: Guided Lovemaking (Audio Player Only)

This is the audio equivalent to what was taught in Steps 1-5 of the product.

These audio files essentially provide real-time coaching for lovers who are in the process of making love or communicating about lovemaking. The files “take the coaching into the bedroom” and make it possible for the lovers to practice what they have been taught without having to refer to memory or distracting books or videos.

The Narrator guides each member of the relationship with specific directions that, when followed, will move the couple through an extraordinary lovemaking process. These files can be used sequentially or selectively depending on the skill set that the lovers want to learn or practice.

Some of the Narrator's words are scripted, recorded and mixed for neurolinguistic programming.

Accompanying the narrator is music and subliminal and/or non-subliminal sound effects for brainwave entrainment; so as lovers follow directions their brainwaves fall into patterns that enhance lovemaking. This also reinforces learning and experiential memory. Over time these brainwave patterns become associated with actual lovemaking so that lovemaking evokes these brainwave patterns and these brainwave patterns evoke and enhance lovemaking.

Users are advised to keep control of the audio player within easy reach while following lovemaking instructions. That way, users can pause the audio whenever they want more time to experience/practice what they are learning.

Of course, an individual in various ways can also use these audio files separately and in conjunction with the rest of the product Steps 1-6. These audio files provide a convenient way to review or pre-view lovemaking skill sets while away from the computer or DVD player.

### Step 8: Lovemaking Support Music/Soundtrack (Audio Player Only)

These audio files consist of the same brainwave entrainment music and sound effects (subliminal and/or non-subliminal) that accompany Steps 6 and/or 7 above. There is no Narrator on these files thus no story or coaching. The music/soundtrack is extended for uninterrupted lovemaking. The music evokes brainwaves that enhance lovemaking while helping the user to recall lovemaking skills taught in the previous Steps.

### Example II

### Components of the Experiential Lovemaking Training Product(s) Kit

The Kit comprises the following components. One of at least six versions, including Experiential Lovemaking Training (ELT) for mature adults aged 46 and above; ELT for younger adults aged 26-45; Advanced ELT for all adults; ELT for young adults aged 18-25; ELT for Japan; Interactive Healing of Sexual Trauma and Dysfunction; Experiential Lovemaking Education for Teens; Experiential Experiential Lovemaking Training for Married Christians; Advanced ELT for Japan.

The Kit comprises categories, general subject area of focus, including foreplay, oral sex, masturbatory sex, sexual intercourse, penis to G-spot contact, penis to cervix contact, pubic bone to clitoris contact, penis to anus contact, penis to penis contact, clitoris to clitoris contact, clitoris to limb contact, and penis to limb; subcategories, more specific area of focus, including synchronizing arousal; Session A comprising a summary of the method; Session B comprising an explanation and demonstration of the method in use; Session C comprising guided practice; Session D comprising game play; and Session E comprising a reward video.

### Example III

### Evaluation of Training

The training is evaluated using cognitive objective analysis. The test comprises something specific that the individual will know as a result of participation in the above sessions, such as knowing that male arousal rates are generally several times faster than female arousal rates. In addition, the game play measures how well the person has learned what is to be known.

The training is also evaluated using affective objective analysis. The test comprises something specific that a individual should be able to do in real life after participating is at least four interactions with a game play component where the individual has attempted to arouse a partner without rejection.

### Example IV

### Experiential Workshops

In experiential workshops with individuals and couples on “Transcendent Sex” and “Sexual-Spiritual Fulfillment for Couples” and the like, the following combinations of steps were used:
Group profiling (written on giant white pads and posted for all to see) to ascertain participants' perceptions regarding the subject matter and their goals and objectives for the workshop, later compared with perceptions at the end of the workshop and evaluations as to whether the goals and objectives were achieved;
Verbal summaries of a subject;
Verbal (audio) explanations of a specific skill or behavior;
Visual demonstrations, including drawn sketches, photocopied pictures, personal demonstrations (such as, breathing rhythms combined with neck and pelvic moves);
Participant experiences (such as, actually practicing breathing rhythms combined with neck and pelvic moves previously demonstrated) while being guided with verbal instruction and at the same time listening to an audio CD with music neuroacoustically treated to entrain brain waves to the 0 range;
Participant experiences (such as, combining above-mentioned breathing and movement practices with eye contact, hugging and/or otherwise touching partner) without being guided with verbal instruction and at the same time listening to audio CD with music neuroacoustically treated to entrain brain waves to the θ range.

### Example V

### Products

One application of the Invention, “Mind-Body Learning System and Methods of Use” are an Experiential Lovemaking Training Products for adults.

The products offer the following seven features and eight benefits.

Features of the Experiential Lovemaking Training Products for Adults

1. State-of-the-Art Learning Technologies: Throughout the product, we employ both time-tested and cutting-edge learning methods and technologies to maximize results. This combination is intrinsic to the overall effectiveness of the program and differentiates it from anything on the market today. Multiple learning modalities Conditioned association and response Specially produced sound technologies to evoke brainwave entrainment Neuro-Linguistic Programming (NLP) Simulation and testing Guided imagery and imaginary practice Guided practice with your partner.

2. Personal Profile: A personal profiling system plays an important role in personalizing the training experience. The profile is designed to help you understand more about your lovemaking strengths, weaknesses, issues and opportunities. It measures your success and growth as you proceed along the training journey. As an option, you can link your profile to our secure on-line database servers for additional benefits.

3. Video Stories for Reinforcement and Reward: Capitalizing on the fact that people learn through, stories, (see, for example, Schank, R. C. 1990. Tell me a story: a new look at real and artificial memory. New York: Scribner.) we weave several episodic stories throughout the product to help you identify the potential impact these new skills may have on your relationship. You enjoy these stories through “reward videos” that are revealed periodically in response to your participation in the training. Each story involves a couple whose intimate relationship is transformed as they apply the knowledge and skills you are learning.

4. Compelling Yet Practical Wisdom and Skills from Experts Worldwide: The information and skills taught are drawn from experts worldwide on great lovemaking. We consolidate valuable information, currently spread over many and varied sources, into one comprehensive, practical training for today's mainstream lovers. The product combines and translates:
ancient sacred lovemaking traditions (Taoist, Tantric, Toltec, Quodoushka),
contemporary psychology,
current sex knowledge,
how to expand your capacity to feel sensual pleasure,
how to build and circulate sexual energy for more powerful full-body orgasms,
genital reflexology,
male multiple orgasm (before ejaculation),
female ejaculation,
expanded orgasm,
prolonged orgasm.

5. Live Performers with Visual Effects and 3D Models: Throughout the program we show lovemaking demonstrations with live action performers, graphic visual effects and/or animated 3D models. This enables simultaneous displays of internal and external anatomy plus illustrations and animations of the energetic, emotional and imaginative “inner experience” (what lovers feel, think, visualize).

6. Interactive Game Play for Simulation and Testing: Interactive game play is used in the simulation and testing portions of each training module. These game play portions engage your mind and body in a spontaneous action—reaction process that makes the learning more experiential. When you produce the correct results, you get positive feedback. For example, you find and stroke on the G-spot and are rewarded with orgasmic sounds of delight!

7. High Definition Video: High definition video (HDV) will be used wherever applicable to add vivid visual energy and make the learning experience more sensuous, dynamic and entertaining.

Benefits of the Experiential Lovemaking Training Product(s) for Adults
1. The program is playfully interactive, entertaining and easy to use.
2. Your training experience is personalized, and you'll receive feedback on your progress during your journey to lovemaking mastery.
3. You'll expand your capacity to experience more sensual pleasure and more powerful orgasms.
4. You'll not only improve your current lovemaking skills, but will discover new possibilities and potentials to enjoy sex beyond what you thought possible.
5. You'll experience rapid learning and enhanced recall.
6. You'll engage in full participation of mind, body and emotions to gradually move your new skills and knowledge into your adaptive unconscious where they'll become a natural part of your lovemaking repertoire.
7. You'll remain enthusiastically engaged through completion of the program, resulting in long-term success.
8. You'll become familiar with and learn to easily enter a state of mind that is highly desirable for ecstatic lovemaking long after you have completed the program.

### Example VI

### How the Experiential Lovemaking Training Products (Application of the Invention) is/are Effective

The product employs several proven principles and technologies for learning. We use these principles and technologies throughout the entire program to maximize its overall effectiveness. We weave them in various combinations consistently throughout the training to, first, enhance learning and recall. Then, gradually, the new knowledge and skills are incorporated into your adaptive unconscious where they will become a natural part of your lovemaking repertoire.

To know how this/these Experiential Lovemaking Training Products will be effective, revolutionary and unique, you must first understand the following underlying principles and technologies.

### Experiential Memory

We know that the current way we make love is the result of what resides in our adaptive unconscious. To improve lovemaking consistently over time, new lovemaking skills must ultimately integrate into your adaptive unconscious. To enable this to happen, these skills must become part of your experiential memory.

Experiential memory is a memory created by personally doing or feeling something; it's the memory of something happening from the inside (see, for example, Stoneham, T. Memory and Knowledge, Department of Philosophy, University of York, Heslington, York, U.K.). In order for something to move into your adaptive unconscious, it must generally be personally experienced, not simply seen or heard (although seeing and hearing may also be involved). The experience can be physical or imaginary, and is more powerful if it involves emotions.

If you move your feet and hips to the pattern of the samba, rather than simply watching the dance instructor do it, you will create an experiential memory. If you repeatedly practice the movements, that experiential memory eventually develops enough strength to begin moving into your adaptive unconscious. You can watch professional dancers do the samba every night, but unless you practice moving your body to the patterns, the dance won't move into your adaptive unconscious, and you're not likely to dance the samba very well, if at all, when the music plays.

Throughout the lovemaking training, you will be invited to repeatedly practice or imagine practicing skills in different ways to build powerful experiential memories.

### Vivid Mental Imagery

Scientific research shows the brain doesn't differentiate very strongly between real and imagined experience. In fact, vivid mental imagery of a situation or activity is perceived as real experience by the body. With sensitive equipment, many scientific experiments have verified that the body responds to vivid imagery with minute muscular contractions and tends to generate organic changes (Hutchison, 1994, Megabrain Power, Hyperion, New York, N.Y., pp. 170, 235-238, 244, 245.). So you can actually create experiential memory by vividly imagining that you are doing or feeling something.

There are many examples of the use of guided imagery in sports psychology, (Hutchison, 1994, supra p. 234-238, but you may recall one of the first groundbreaking experiments, the widely publicized “basketball experiment” (Sports Visualizations, Llewellyn Encyclopedia, see world wide website at llewellynencyclopedia.com/article/244). Australian psychologist Alan Richardson tested three groups of basketball players on their ability to make free throws on the first and twentieth days of the experiment. None had ever practiced visualization. He instructed the first group to spend twenty minutes a day practicing free throws. The second group was not to practice at all. The third group spent twenty minutes a day visualizing that they were shooting perfect baskets, but never stepped on a court. If they “missed” in their imagination, they were to “practice” getting the next shot right. The first group improved 24%. Of course, the group that did nothing showed no improvement. But through the power of imagery alone, the third group improved an astonishing 23%, almost as much as the group that physically practiced.

Mental imagery has been applied to many areas of personal improvement, and can contribute to

Experiential Lovemaking Training as well. For example, if you vividly imagine giving a sexual massage while being lead by a narrator during a guided visualization, you will develop experiential memories and a level of competency before you actually try it with your partner.

So it stands to reason that guided imagery and/or imaginary practice sessions are included in every subject module of the Experiential Lovemaking Training Products. These enjoyable practices create experiential memories and incorporate new knowledge and skills into your adaptive unconscious where they will be available to you when you use your new skills with a partner.

### Simulation and Testing

Simulation and Testing is another time-honored method of creating experiential memory to move skills into the adaptive unconscious when actual practice is too expensive or risky. For instance, fighter pilots and astronauts often use simulated flying experiences to prepare them for the real thing. Likewise, you can practice a new lovemaking skill, like sexual massage, through a game-like simulation giving you experience you can apply to the real thing.

### Multiple Learning Modalities

Educational research has established that when information is delivered via more than one modality (e.g., visual images, reading, listening, writing, imagining, touching, smelling, manipulating, etc.), we “store” that information in various places within our brains. As a result, more learning actually takes place and is remembered longer. Activating more learning modalities also enables you to recall information more readily, because it's easier to “find” when it's stored in many locations (see, for example, Educational Leadership: How the Brain Works, 1998; Jensen, E. Teaching with the Brain in Mind. Alexandria, Va.: ASCD). The Experiential Lovemaking Training Product(s) engage(s) multiple modalities, including, visual, auditory, kinesthetic, touch, and imagination.

### The Theta Brainwave State

Different brainwaves are useful for different functions. Beta, the common brainwave speed of typical waking consciousness (30-13 Hz) is involved in cognitive processes and supports mental focus and processing information. You generate beta brainwaves to balance your checkbook, plan your day or follow a recipe. Slower alpha brainwaves (13-8 Hz) facilitate relaxed alertness, receptivity, and creative production. You probably produce alpha while watching television, driving on the open road, painting a picture, free dancing and during light meditation (Hutchison, 1994, supra, pp. 26, 33).

We often think of theta brainwaves (8-3.5 Hz) as being those activated when we are dreaming or in deep meditation. But we can also generate theta while active and awake (Hutchison, 1994, supra, p, 33). As young children, we spent most of our waking hours generating predominantly theta brainwaves (Hutchison, 1994, supra, pp. 31, 32) until the demands of cultural development, logic and linear thinking, including reading, writing and arithmetic, required us to produce more dominant beta. Young children are the master learners, and in the last half century science has documented that the theta brainwave state is the state of “super-learning” (Hutchison, 1994, supra, pp. 29, 208). It has also been shown that if we learn to generate more waking theta waves as adults, we reap those benefits as well.

Effects of the waking theta brainwave state are particularly helpful in learning new skills, including better lovemaking. These attributes include improved memory, enhanced creativity, recognizing patterns, a holistic perspective, and more efficient and effective integration of new knowledge and experience into the adaptive unconscious (Hutchison, M., 1986, Megabrain. New York, N.Y.: Beech Tree Books, William Morrow, p. 29; Hutchison, 1994, supra, pp. 33, 208-209, 329).

Theta brainwave patterns can directly enhance your sexual experience because in this state, you experience increased sensory perception and awareness of your body, increased emotional awareness, intimacy, greater tolerance, understanding, and openness to self-love and love for your partner (Hutchison, 1994, supra, p 29).

So, you may ask, “How can I generate more waking theta brainwaves and reap all these rewards? How can I activate my ‘super-learning’ abilities and enter theta states at will for enhanced lovemaking?” One way is by regular deep meditation. Brain research has shown that those adept at meditation begin to retain the high-voltage, slow brainwave activity of the meditative state when they are engaged in everyday tasks (see, for example, Wade, J., (1996). Changes of mind: A holonomic theory of the evolution of consciousness. Albany, N.Y.: SUNY Press). These people thus enjoy the benefits of increased theta while engaged in ordinary activities, like work, raising children and preparing a meal.

However, meditation is not the only way to the theta state.

### Brainwave Entrainment

Entrainment is a widespread natural phenomenon. Pendulum clocks in a Swiss clock factory will synchronize their “tick-tocking” within days, the menstrual cycles of women who live in dormitories or other communal situations will often synchronize over time, and a person's brain waves will tend to synchronize, or entrain, with specific external stimuli, such as a metronome or strobic light.

Certain types of rhythmic stimulation, such as drumming, or precise combinations of pulsating light and/or sound can evoke the theta state (Wade, J., 1996, Changes of mind: A holonomic theory of the evolution of consciousness. Albany, N.Y.: SUNY Press, pp. 61,88). This is why sound technologies play an important role in For the Love of Sex.

When your brain has practice accessing theta brainwaves through sound stimulation while you're awake, it creates new neural networks, much like laying down a footpath in the woods to a favorite destination. It becomes part of your experiential memory. Your brain can later use that path to easily find that state of mind more quickly and easily, while learning new skills or making love (Wade, J., 1996, Changes of mind: A holonomic theory of the evolution of consciousness. Albany, N.Y.: SUNY Press, pp. 89, 143).

The Experiential Lovemaking Training Product blends and mixes specialized sounds and music throughout the program, to help entrain your brainwave patterns into the theta range so you rapidly learn and integrate new knowledge and skills, all for the purpose of ecstatic lovemaking. When we combine these acoustic brainwave entrainment technologies with game-play simulation, guided lovemaking practice and other learning methods and technologies, we begin to grasp the enormity of what's possible in the realms of lovemaking and lovemaking training.

### Conditioned Association and Conditioned Response

It's a biological response to salivate when you smell or eat food, but not when you hear a bell ring. When Pavlov rang a bell every time he fed his dogs, he developed in them a conditioned association between food and the sound of the bell. Eventually, the association was so well established, that the dogs would salivate when the bell rang, even when no food was present. In this way, the natural response of salivating for food was used, through conditioned association, to develop the conditioned response of salivating upon hearing a bell (Pavlov (1903) “The Experimental Psychology and Psychopathology of Animals” International Medical Congress, Madrid).

In the same way, if you listen to a special soundtrack designed to evoke a particular brainwave state, like theta, the natural response is for your brainwaves to slow down into theta range, and you begin to experience the corresponding state of mind. If you listen to the same soundtrack while you are guided to imagine practicing or actually practice sexual massage with a partner, for instance, you will begin to associate the sound track and the mental state it evokes with sexual feelings and behaviors.

It works two ways with brainwaves. This means that eventually, through the conditioned association between the theta state and sexual feelings and behaviors, you will develop a conditioned response and be able to find your way to and enjoy the theta state of mind when sexual feelings and behaviors arise, even if the soundtrack is no longer present. The resulting enhanced sexual experience then reinforces theta brainwave patterns, and theta brainwave patterns reinforce the enhanced sexual experience. Over time, these enhanced experiences will become part of your adaptive unconscious and contribute to your ever-expanding ecstatic lovemaking life, long after you've completed the Lovemaking Training.

Teaching with Stories

Stories are fundamental to both understanding and learning. Since pre-Biblical times, expert teachers have often used stories to teach. Some would argue that all learning comes through narrative (Schank, R. C., 1990, supra). This is why episodic reward video stories are included in every subject module of the Experiential Lovemaking Training Products.

### Neuro-Linguistic Programming

Based on common associations within the adaptive unconscious, sensory input can be used to elicit thoughts, emotions, attitudes and behaviors. Through conditioned response, words, images, and sounds commonly associated with personal empowerment, self-expression, and a positive self-image can be used to empower life skills.

NLP was devised to help people become aware of their unconscious limiting thought and behavior patterns, and to show them how they can change these automatic patterns and create new ways of thinking and feeling. These new patterns open up new choices and behaviors that help people achieve their goals. NLP can be applied to any type of human activity, from business to social relations. It is frequently used in personal growth programs and to enhance the healing process.

An NLP expert works with us to incorporate NLP techniques into the scripts for all aspects of the training throughout the Experiential Lovemaking Training Products to further enhance effectiveness.

The Experiential Lovemaking Training Products integrate all of these learning methods and technologies, in various combinations, using the invention “Mind-Body Learning System and Methods of Use”.

### Example VII

### The Content of the Experiential Lovemaking Training Products (Application of the Invention “Mind-Body Learning System and Methods of Use”)

The Experiential Lovemaking Training Products include approximately thirty subject modules in all, resulting in hours of linear and interactive course content.

The content of the Experiential Lovemaking Training Products are on DVD-ROM and audio CD with CD audio files and MP3 file options.

The DVD-Rom is formatted to play on both a Macintosh and a Windows computers and provides an interactive format for optimum learning.

The main menu of the Experiential Lovemaking Training Product interactive format includes the following choices:
Product Overview
   This gives you a guided tour of the product. It includes instructions, demonstrations and how to benefit most from this learning experience.
Personal Profile
   This is our first piece of interactivity beyond the simple menu selections. You will encounter a playful questionnaire designed to gather information about your strengths and weaknesses around lovemaking. You will receive encouraging feedback on your “lovemaking personality type” plus recommendations for training. It lets you know who you are in a world of all possible lovers and opens your mind to new lovemaking options. With this information, the program will begin to personalize your training experience. As you progress through the program, your profile will grow as you answer questions at the beginning of each subject module. This profile automatically updates, based on your simulation and test results. When you complete the entire training, your initial personal profile will be compared to your final profile. This validates all you've learned. You are given the option to upload your profile data to Extatica's on-line database to make it easy to compare with your partner.
A choice of two routes through the program:
   The Path To Mastery (recommended)
   Choose Your Own Path
Video Stories

### Routes Through the Program

You have a choice of two ways to move through the program (1) Path to Mastery and (2) Choose Your Own Path. We recommend the Path to Mastery for optimum learning, but understand that some people may prefer to skip around according to their interests.

The subject modules, covered sequentially in the Path to Mastery, are located in three parts:
1. Fundamental Information
2. Expand your Capacity for Pleasure
3. Expand, Refine, Strengthen Your Lovemaking Repertoire.

Fundamental Information will contain five or six subject modules that do not involve the 8-Step Method. Most of these topics can be easily referenced throughout the course with visible links.

Parts 2 & 3 contain approximately 20 subject modules in total, and each module is presented using the 8-Step Method.

The following are examples of subject modules you will cover as you progress through the three parts of the program:

1. Foundational Information for Enhanced Lovemaking:

The Many Dimensions of Sex—types of orgasms and orgasmic states (men's types, women's types, multiple, extended, expanded, streaming), transpersonal sex, transcendent sex, sexual-spiritual fulfillment

Sexual Anatomy, Physiology and Other Sex Facts—the most current information

The “Silent Sync” between lovers—what it is, how it helps you experience more pleasure and connect more deeply with your lover, and how to help it happen

Sexual and Emotional Energetics

Sources of Lovemaking Information

Each subject module in the next two parts is presented using the 8 Step method of the invention “Mind-Body Learning System and Methods of Use” an 8-step process that will gradually integrate the material into your adaptive unconscious. Each step is designed to take you to a deeper level of mind-body assimilation involving various combinations of the learning methods and technologies. Each of these subject modules varies in length, according to how much time you want to spend.

2. Expand Your Capacity for Pleasure:

How to Feel and Experience More Pleasure—physically, emotionally and energetically

Unblock Sexual Energy—to liberate more powerful full-body orgasms

Self Love and Self Pleasure

Expand Your Capacity to Handle a High Sexual Charge

Build a Powerful Sexual Charge and Enhance Your Orgasmic Capacity

Circulate Sexual Energy—for more full-body pleasure for you and your partner

Use Your Voice to Enhance Your Pleasure

3. Expand, Refine and Strengthen your Lovemaking Repertoire:

You'll learn myriad ways to interact with your lover, from seduction to afterglow, including:

Closing the Gap in Masculine and Feminine Arousal and Response Rates

Intimate Communication and Feedback

Touch

Kissing

Sensual and Sexual Massage

Oral-Genital Pleasuring

Male Orgasm and Ejaculation—types, delaying ejaculation, multiple orgasms (before ejaculation), how to stimulate them

Female Orgasm and Ejaculation—types, multiple orgasms, female ejaculation, how to stimulate them

Sexual Variations and Techniques—how and when to use them

Toys and Sexual Enhancement Products—introducing them into your lovemaking, ways to use

Intercourse—angles of penetration, thrusting patterns, pelvic moves

How to Assess a Sexual Position—to maximize intimacy and orgasmic response

Pacing—from foreplay to continuous play for prolonged and expanded lovemaking

### Example VIII

### Components of the Experiential Lovemaking Training Products Box Set

The Box Set includes: (1) DVD, (I) DVD-Rom, (3) Audio CDs, (1) Booklet. The DVD-Rom (plays on Windows and Macintosh computers) includes all linear and interactive portions of the product. A graphical interface is used for navigation. The computer keyboard and mouse are used for interactivity.

The DVD (plays on all DVD players) Includes all linear portions of the product and uses the DVD remote as a mechanical interface for navigating the user menu.

The first Audio CD and set of MP3 Files includes all Guided Visualizations and Guided Exercises.

The second Audio CD and set of MP3 files includes all Guided Lovemaking Soundtracks.

The third Audio CD and MP3 Files includes all musical soundtracks for lovemaking without narration.

The Booklet is a personal workbook for people without a computer, includes: self-scoring Personal

Profile, abbreviated exercises, and helpful tips.

### Example IX

### The 8 Step Method Applied to the Experiential Lovemaking Training Product) as an Application of the “Mind-Body Learning System and Methods of Use”

This is how the 8 Step Method works. Each subject or skill taught in the Experiential Lovemaking Training Product is conveyed through 8 steps. Like going up a flight of stairs, each step takes you to a higher level of mind-body assimilation of the knowledge and skills until they are finally integrated in your adaptive unconscious. As with all the steps, you are developing access to an increasingly holistic perspective, integrating knowledge on many levels (including emotional), and weaving a neural-network of connections that amplifies the relevance of the new learning to your own life. Again, the purpose of learning in this way is, once they are incorporated into your adaptive unconscious, the new knowledge and skills will be available to you, naturally and spontaneously, when you make love.

STEP 1—Profile Update

STEP 2—Summary of Training Module

STEP 3—Demonstration and Explanation

STEP 4—Simulation and Testing

STEP 5—Reinforcement/Reward Video

STEP 6—Guided Visualization/Guided Solo Practice

STEP 7—Guided Lovemaking

STEP 8—Lovemaking Support

Most subject modules use 8 steps in the course design. We've chosen the subject of Sexual Message to illustrate how the 8 steps work.

STEP 1—Profile Update
Format: DVD-Rom, Self-Scoring Booklet

Description/Example:
You respond to a few questions about sexual message. These will be added to your growing personal profile to be viewed at a later date. For example: Are you confident you give a pleasing message? Have ever experienced a terrific sexual massage? Have you ever felt that giving a sexual message was as pleasurable as receiving one?

Benefit:
Increases understanding of yourself and your partner (if you have one)
Helps you understand more about your lovemaking strengths and weaknesses, issues and opportunities
Learning effectiveness is greatly enhanced by relating the information to your experience and current level of knowledge
Can be used to facilitate communication between partners regarding intimate issues
Gives you a measure of your accomplishment when your updated profile answers are later compared to your initial ones.

STEP 2—Summary of Training Module
Format: DVD-ROM, DVD

Description/Example:
You watch a summary video montage of various couples engaged in sexual massage. Narration briefly describes:
   the difference between sensual, sexual and other massage,
   the value of sexual massage for intimacy and sexual satisfaction
   a brief overview of what you will be taught during the training module.

Benefit:
Education research indicates that you learn faster and retain more of what you have learned when you have an overview of the information you are about to consume. It peaks your interest, and you begin to build a cognitive file in which to organize and integrate the new knowledge with what you already know.

STEP 3—Demonstration and Explanation
Format: DVD-ROM, DVD

Description/Example:
You see a video of a couple engaged in a sexual massage. The narrator begins to teach with step-by-step demonstrations using visual effects for views of both outside and inside the body. This is where the primary teaching for the subject module is first introduced.

It shows you:
how to work with your hands, fingers, palms, forearms, and other parts of your body
where, when, and how to touch
how to read your lover's response and ways of communicating with your lover
how to build and sustain sexual energy as a prelude to other forms of lovemaking
how to build and release sexual energy for completion
Pressure points, energy build and energy flows are fully illustrated.

Benefit:
By viewing real people demonstrating the teaching, you receive the information in a visceral and relevant way.
You get a play-by-play view of what sexual massage is all about and how to do it.
Graphic illustration of internal anatomy and sexual energy helps you understand what is going on at a deeper level, physically, energetically and emotionally.

STEP 4—Simulation and Testing
Format: DVD-ROM

Description/Example:
Now you get to practice and see how much you've learned before you try it with your lover. This is part of an episodic lovemaking game that threads through the entire product. Here's what happens:
   Using your computer mouse and arrow keys, you engage in a simulated sexual massage by controlling 3D characters.
   The physical interaction between these characters will generate feedback in the form of sounds and/or computer-animated characters.
   When the character you control does the “right things, in the right way, at the right time,” your simulated lover responds with motions, moans and groans of orgasmic pleasure, and a high score is added to your personal profile.

Benefit:
This interactivity makes the learning more “experiential”. It reinforces and validates what you've learned in a playful and entertaining way.

STEP 5—Reinforcement/Reward Video Stories
Format: DVD-ROM, DVD

Description/Example:
Once your score reaches a certain level, you are offered a reward video. This is a short episode in the ongoing story of couples whose lovemaking training, specifically in this module, sexual massage, changed their relationships. Through this episode of the couples' stories, you will:
   See several ways that mutually pleasing sexual massage affects their evolving relationship on a physical and emotional level.
   Better understand what you have learned and how to integrate your newly acquired knowledge into your own love life

Benefit:
You are able to see through the couples' stories how your relationship can grow by using these teachings.

STEP 6—Guided Visualization/Guided Solo Practice
Format: Audio CD, MP3, also on DVD-ROM, DVD

Description/Example:
You listen to guided visualizations and/or guided exercises. In this example, you will be guided to imagine giving and receiving sexual massage.
Benefit:
   The more vividly you imagine giving and receiving a sexual massage, the more spontaneous and masterful you will be when you actually do it with your partner.
   Enables you to enhance your skills and the subtle nuances of sexual massage.

STEP 7—Guided Lovemaking
Format: Audio CD, MP3, also on DVD-ROM, DVD

Description/Example:
You practice sexual message with your partner to a sensuous neuro-acoustically treated musical soundtrack behind a narrator's voice. The narrator provides unobtrusive audio coaching to assist you in using your newly acquired or improved skills.

Benefit:
Takes the pressure off of having to remember and “do it right” the first time.
Is easy and relaxing as you follow the gentle coaching.
Helps facilitate communication between you and your lover as the narrator guides you to share what you are feeling and give verbal or other feedback.
The secret is in the soundtrack. It has been specifically designed to incorporate learning modalities discussed earlier. By this time you will associate the music with giving/receiving sexual message and with being in an emotionally receptive sensuous state.

STEP 8—Lovemaking Support
Format: Audio CD, MP3, also on DVD-ROM, DVD

Description Example:
You play the same musical soundtrack as used in Step 7 (Guided Lovemaking), but without the narrative coaching, during sexual massage or lovemaking.

Benefit:
By the time you get to this final step, you will associate the music with the memory of how to do sexual message.
At this point you will connect the music so fully to the learning that the narrator's voice is no longer necessary to recall how to do sexual massage.
Provides wonderful mood setting and lovemaking enhancement by evoking theta brainwaves that engender relaxation, empathy, intimacy and sensual enjoyment.
You reinforce your ability to access the theta state later on without the soundtrack.

### Results of the 8 Step Method

Having climbed the 8 Step stairway to lovemaking mastery, the user of this Experiential Lovemaking Training Product will feel confident and empowered as a lover; will find it easy and natural to call upon his or her newly acquired or improved lovemaking skills and behaviors; and will enjoy sex more. If the user of this Experiential Lovemaking Training Product has a lover, the intimate connection with that lover will be deepened and their love life will be vastly improved.

### Summary Value

The product is Experiential Lovemaking Training for the modern world. It applies the best of what's known about how people learn to the best of what's known about magnificent sex while providing complete Experiential Lovemaking Training to mainstream adults in a way that is engaging, fun, truly effective and has an enduring positive impact on intimate relationships and sexual fulfillment. Imagine the beneficial “trickle-down effects” for a world in which a deeply fulfilling love life is the norm.

### Example X

### Additional Evaluation of Training and Health

The training is evaluated using a questionnaire presented to subjects before and after training. The questionnaire comprises questions regarding the subject's interests, subjects preferences, subject's goals, subject's previous experience, subject's current knowledge, questions that reveal the subject's capacity for intimacy, and subject's ability and satisfaction regarding sex and intimacy. The questionnaire is used to evaluate the benefits of the training. Also evaluated separately are several indicators of health, such as blood pressure, heart rate before and after exercise, core temperature, liver enzymes, urine analysis, serum triglyceride level, serum fatty acid level, serum cholesterol level, serum HDL level, serum LDL level, serum protein level, serum sugar level, various skin-fold thicknesses, bicep and calf circumferences, body weight, lean body mass, percent body fat, body mass index (BMI), and waist-to-hip ratio (WHP). In addition, tissue biopsies can be performed to measure tissue metabolism and gene transcriptional activity.

Those skilled in the art will appreciate that various adaptations and modifications of the just-described embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention can be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

TABLE 1
Exemplary Components and Embodiments of Lovemaking Training Kits

| | | Experiential Lovemaking Training: | | | | | | | | | | | | Advanced Lovemaking Training: | | | | | | | | | | | |
|---|---|---|---|---|---|---|---|---|---|---|---|---|---|---|---|---|---|---|---|---|---|---|---|---|---|
| | | Embodiments | | | | | | | | | | | | Embodiments | | | | | | | | | | | |
| STEPS | Lovemaking Training | 1 | 2 | 3 | 4 | 5 | 6 | 7 | 8 | 9 | 10 | 11 | 12 | 1 | 2 | 3 | 4 | 5 | 6 | 7 | 8 | 9 | 10 | 11 | 12 |
| 1 | User Profile/ | X | | | | | X | | X | X | | X | X | X | | | | | X | | X | X | | X | X |
| | Couples Profile | | | | | | | | | | | | | | | | | | | | | | | | |
| 2 | Summary | | | | | X | X | | X | X | | X | X | | | | | X | X | | X | X | | X | X |
| 3 | Demonstration/ | | | | | X | X | | X | X | | X | X | | | | | X | X | | X | X | | X | X |
| | Explanation | | | | | | | | | | | | | | | | | | | | | | | | |
| 4 | Simulation and Testing | | | | | | | X | | X | | X | X | | | | | | | X | | X | | X | X |
| | (one player game) | | | | | | | | | | | | | | | | | | | | | | | | |
| 5 | Reinforcement/ | | | | | X | X | | X | X | | X | X | | | | | X | X | | X | X | | X | X |
| | Reward Video | | | | | | | | | | | | | | | | | | | | | | | | |
| 6 | Guided Visualization | | X | | X | | | | X | X | | X | X | | X | | X | | | | X | X | | X | X |
| 7 | Guided Lovemaking | | | X | X | | | | X | X | | X | X | | | X | X | | | | X | X | | X | X |
| 8 | Lovemaking | | X | X | X | | | | X | X | | X | X | | X | X | x | | | | X | X | | X | X |
| | Support Music | | | | | | | | | | | | | | | | | | | | | | | | |
| | Two Player Game | | | | | | | | | | X | X | X | | | | | | | | | | | | |
| | Bio Feeback System(s) | | | | | | | | | | | | | | | | | | | X | | X | | X | X |

| | |
|---|---|
| Product Family 1 | Product Family 2 |
| Product 1: Adults All Ages | Product 6: All Adults Heterosexuals |
| Product 2: Ages 18-26 | 1 Product × 10 embodiments = 10 embodiments |
| Products: Japanese Adults | No One/T wo player game |
| Product 4: Lesbian Adults | No box set with One/Two-Player game |
| Product 5: Gay Adults | Total Embodiments for all 3 product families = 78 |
| 5 products × 12 embodiments = 60 embodiments | |

| | | Healing Sexual Trauma and Psych | | | | | | | | | | | |
|---|---|---|---|---|---|---|---|---|---|---|---|---|---|
| | | Based Dysfunction: Embodiments | | | | | | | | | | | |
| STEPS | Lovemaking Training | 1 | 2 | 3 | 4 | 5 | 6 | 7 | 8 | 9 | 10 | 11 | 12 |
| 1 | User Profile/ | X | | | | | X | | X | X | | | X |
| | Couples Profile | | | | | | | | | | | | |
| 2 | Summary | | | | | X | X | | X | X | | | X |
| 3 | Demonstration/ | | | | | X | X | | X | X | | | X |
| | Explanation | | | | | | | | | | | | |
| 4 | Simulation and Testing | | | | | | | X | | X | | | X |
| | (one player game) | | | | | | | | | | | | |
| 5 | Reinforcement/ | | | | | X | X | | X | X | | | X |
| | Reward Video | | | | | | | | | | | | |
| 6 | Guided Visualization | | X | | | | | | X | X | | | X |
| 7 | Guided Lovemaking | | | | | | | | X | X | | | X |
| 8 | Lovemaking | | X | | | | | | X | X | | | X |
| | Support Music | | | | | | | | | | | | |
| | Two Player Game | | | | | | | | | | | | |
| | Bio Feeback System(s) | | | | | | | X | | X | | | X |

Product Family 3
Product 7: All Age Heterosexuals
1 Product × 8 embodiments = 8 embodiments
No Guided Lovemaking
No combination of Guided Visualization and Guided Lovemaking
No One/Two-Player game
No Box set with One/Two Player game
Exemplary Embodiments: (1) Personal & Couples Profile (2) Guided Visualizations (3) Guided Lovemaking (4) Guided Visualizations + Guided Lovemakiing (5) Linear Video (6) Profiles + Linear Video (7) One-Player Game (8) Box Set w/o game (9) Box set with game (10) Two-Player Game (11) Box Set with One/Two-Player Game (12) Workshops

1. An educational method for training a trainee, the training resulting in an improved sensual and sexual experience for the trainee, the method comprising the steps of: (i) providing at least one image to the trainee, the image comprising at least one human body part; (ii) providing at least one video recording to the trainee, the video recording comprising at least one human indulging in an activity, the activity selected from the group consisting of sensual activity, sexual activity, verbal communication, and non-verbal communication; (iii) providing at least one audio recording to the human subject, the audio recording comprising a sound; (iv) presenting the image to the trainee for at least 1/60 of a second; (v) presenting the video recording to the trainee for at least 1/30 of a second; (vi) presenting the audio recording to the trainee for at least 1/60 of a second; wherein performing any one of steps (i), (ii), (iii), (iv), (v), and (vi) elicits a response in the trainee; (vii) evaluating the trainee's response to create a score; (viii) categorizing the response according to the score; (ix) recording the category of the trainee's response; (x) presenting the category to the trainee; (xi) optionally repeating any one of steps (i), (ii), (iii), (iv), (v), (vi), (vii), (viii), (ix), and (x) at least once; and (xii) comparing a score created at any step with a score created at another step, wherein an increase in the score correlates with an improved sensual and sexual experience; the educational method resulting in an improved sensual and sexual experience for the trainee.

2. The method of claim 1 wherein the training is experiential training and wherein the trainee achieves an enhanced emotional response.

3-8. (canceled)

9. The method of claim 1 wherein the sound is selected from the group consisting of a mantra, music, a voice a synthetic sound a natural sound, subliminal sound and non-subliminal sound.

10-21. (canceled)

22. The method of claim 1, wherein the step of evaluating comprises evaluation selected from the group consisting of presenting the trainee a profile questionnaire, inputting responses to the questionnaire, automated scoring using software, self-scoring of the trainee, testing the training of the trainee through game play, reinforcing the training of the trainee through game play, testing the training of the trainee through simulation and game play, reinforcing the training of the trainee through simulation and game play, evaluating the training of the trainee using a Tellegen Absorption Scale, evaluating the training of the trainee using cognitive objective analysis, evaluating the training of the trainee using affective objective analysis, providing feedback to the trainee, testing the brain wave profile of the trainee using an electroencephalogram, testing the breathing rate of the trainee, testing the heart rate of the trainee, performing cognitive objective analysis of the trainee testing for biochemical changes of the trainee and testing for a physiological reaction of the trainee.

23. (canceled)

24. The method of claim 22, wherein the profile questionnaire comprises questions comprising topics selected from the group consisting of interests, preferences, goals, previous experience, current knowledge, questions that reveal the trainee's capacity for intimacy, and questions that reveal the trainee's ability and satisfaction regarding sex and intimacy.

25-46. (canceled)

47. The method of claim 2, wherein the training method comprises an 8-Step Method of experiential training and wherein the synergistic relationship between the steps of the educational method result in a more improved training and learning process.

48-51. (canceled)

52. An educational method for skill training a trainee using learning experience, the skill training resulting in an improved activity for the trainee, the method comprising the steps of: (i) providing at least one image to the trainee, the image comprising at least one human body part; (ii) providing at least one video recording to the trainee, the video recording comprising at least one human indulging in an activity, the activity selected from the group consisting of sports activity, recreation activity, personal growth activity, exercise activity, energetic arts activity, communication skills activity, verbal communication, and non-verbal communication; (iii) providing at least one audio recording to the human subject, the audio recording comprising a sound; (iv) presenting the image to the trainee for at least 1/60 of a second; (v) presenting the video recording to the trainee for at least 1/30 of a second; (vi) presenting the audio recording to the trainee for at least 1/60 of a second; wherein performing any one of steps (i), (ii), (iii), (iv), (v), and (vi) elicits a response in the trainee; (vii) evaluating the trainee's response to create a score; (viii) categorizing the response according to the score; (ix) recording the category of the trainee's response; (x) presenting the category to the trainee; (xi) optionally repeating any one of steps (i), (ii), (iii), (iv), (v), (vi), (vii), (viii), (ix), and (x) at least once; and (xii) comparing a score created at any step with a score created at another step, wherein an increase in the score correlates with an improved activity using learning experience; the educational method resulting in an improved activity for the trainee.

53. The educational method of claim 52 wherein the training is experiential training and wherein the trainee achieves an enhanced emotional response.

54. The educational method of claim 52 wherein the skill training is selected from the group consisting of training for operating machinery, training for performing surgical procedures, training for operating a vehicle, training for teaching a method, training for performing in a public performance, training for performing in a private performance, training for sports, training for golf, training for tennis, training for sailing, training for dance, training for surfing, training for snowboarding, training for skiing, training for personal growth, training for meditation, training for yoga, training for T'ai Chi, training for Qigong, training for Pilates, training for martial arts, training for communication skills, training for understanding and communicating with the opposite sex, training for an improved sensual and sexual experience for the trainee, training for public speaking, training for sales training, and training for management training.

55. The educational method of claim 52, wherein the step of evaluating comprises evaluation selected from the group consisting of presenting the trainee a profile questionnaire, inputting responses to the questionnaire, automated scoring using software, self-scoring of the trainee, testing the training of the trainee through game play, reinforcing the training of the trainee through game play, testing the training of the trainee through simulation and game play, reinforcing the training of the trainee through simulation and game play, evaluating the training of the trainee using a Tellegen Absorption Scale, evaluating the training of the trainee using cognitive objective analysis, evaluating the training of the trainee using affective objective analysis, providing feedback to the trainee, testing the brain wave profile of the trainee using an electroencephalogram, testing the galvanic skin response of the trainee, testing the breathing rate of the trainee, testing the heart rate of the trainee, performing cognitive objective analysis of the trainee, testing for biochemical changes of the trainee, and testing for a physiological reaction of the trainee.

56. The educational method of claim 53, wherein the training method comprises an 8-Step Method of experiential training and wherein the synergistic relationship between the steps of the educational method result in a more improved training and learning process.

57. A kit comprising instructions for an educational method for skill training a trainee using learning experience, the skill training resulting in an improved activity for the trainee, at least one audio recording recorded on a recordable and playable medium, at least one video recording recorded on a recordable and playable medium, at least one interactive software program, the software program recorded on a playable medium, and at least one permanent media storage and retrieval medium, and wherein the educational method for skill training comprises the educational method of claim 52.

58. The kit of claim 57 wherein the recordable and playable medium is selected from the group consisting of an audio tape, a video tape, a compact disc (CD), a CD-ROM, a DVD, a DVD-ROM, an MP3 recorder, a digital audio file recorder, a digital video file recorder, a hard disk drive device, a laser disc, a computer memory chip, nanotechnology systems, molecular-scale storage devices, atom-scale storage devices, optical recording devices, and storage devices.

59. The kit of claim 57 wherein the permanent media storage and retrieval medium is selected from the group consisting of an audio tape, a video tape, a compact disc (CD), a CD-ROM, a DVD, a DVD-ROM, an MP3 recorder, a digital audio file recorder, a digital video file recorder, a hard disk drive device, a laser disc, a computer memory chip, nanotechnology systems, molecular-scale storage devices, atom-scale storage devices, optical recording devices, and storage devices.

60. The kit of claim 57 wherein the kit comprises an 8-Step Method of experiential training.

61. The kit of claim 60 wherein a synergistic relationship between the steps of the educational method result in a more improved training and learning process.

62. A training system, the training system comprising instructions for an educational method for skill training a trainee using learning experience, the skill training resulting in an improved activity for the trainee, and, in electronic communication with each other, a permanent media storage and retrieval medium, a data storage facility, and further comprising stored in the data storage facility, a software program and at least one database to implement the educational method wherein the software program comprises procedures to effect the educational method, and wherein the educational method for skill training comprises the educational method of claim 52.

63. The training system of claim 62 wherein the permanent media storage and retrieval medium is selected from the group consisting of an audio tape, a video tape, a compact disc (CD), a CD-ROM, a DVD, a DVD-ROM, an MP3 recorder, a digital audio file recorder, a digital video file recorder, a hard disk drive device, a laser disc, a computer memory chip nanotechnology systems, molecular-scale storage devices, atom-scale storage devices, optical recording devices, and storage devices.

64. The training system of claim 62 wherein the permanent media storage and retrieval medium comprises an 8-Step Method of experiential training.

65. The training system of claim 64 wherein a synergistic relationship between the steps of the educational method result in a more improved training and learning process.

66. A computerized training system comprising instructions for an educational method for skill training a trainee using learning experience, the skill training resulting in an improved activity for the trainee, and, in electronic communication with each other, a data processing unit, random access volatile memory available to the data processing unit, an audio device to audibilize output from the computerized system to be heard by the user, and a visual display device to visualize output from the computerized system to be seen by the user, the computerized system having access to a data storage facility and further comprising stored in the data storage facility, a software program, and at least one database to implement the educational method, wherein the software program comprises procedures to effect the educational method, and wherein the educational method for skill training comprises the educational method of claim 52.

67. The computerized training system of claim 66 wherein the audio device and the display device are in wireless communication with the data processing unit and the data storage facility.

68. The computerized training system of claim 66 wherein the audio device and the display device are in optical communication with the data processing unit and the data storage facility.

69. The computerized training system of claim 66 wherein the educational method comprises an 8-Step Method of experiential training.

70. The computerized training system of claim 69 wherein a synergistic relationship between the steps of the educational method result in a more improved training and learning process.
